(19) United States
(12) Patent Application Publication
(10) Pub. No.: US 2006/0041345 A1
(43) Pub. Date: Feb. 23, 2006

(54) System for safely disabling and re-enabling the manual vehicle control input of aircraft and other vehicles

(76) Inventor: Darrell Metcalf, Fillmore, CA (US)

Correspondence Address: Darrell Metcalf, 905 N. Oak Avenue, Fillmore, CA, 93015, US

(21) Appl. No.: 10/913,729

(22) Filed: Aug. 9, 2004

(51) Int. Cl. G01M 17/00

(52) U.S. Cl. 701/33; 340/5.2

(57) ABSTRACT

The invention pertains to the field of security for aircraft and other vehicles, and more particularly to systems for preventing the hijacking, commandeering or suicide bombing of aircraft, or other vehicle(s). Aircraft system and vehicle system embodiments of the invention have one or more kinds of automating computers capable of safely controlling either an aircraft or vehicle in one or more types of common, well-proven, or yet-to-be-developed, computer-automated modes. The system provides mechanical control linkage disabling means interfaced with control signal receiving means responsive to wireless, or hard-wired, transmitted security-related control signal(s). Control linkage disabling means are located within a series of physical control linkage components of a vehicle at a point subsequent to where manual control input is initiated and prior to where computer automated control is provided. The disabling means renders ineffectual the mechanical control needed for one or more humans to control or direct a vehicle.

### CROSS-REFERENCE TO RELATED APPLICATIONS

This is a non-provisional patent application which relies on provisional patent application No. 60/491,834 filed Aug. 4, 2003 and is also related to provisional application No. 60/322,904 filed Sep. 17, 2001 and its respective non-provisional patent application Ser. No. 10/246,073 filed Sep. 19, 2002.

### FIELD OF THE INVENTION

The present invention pertains to the field of security for aircraft and other vehicles, and more particularly to systems for preventing the hijacking, commandeering or suicide bombing of aircraft, or other vehicle(s). The aircraft systems have one or more kinds of flight automating computers capable of safely flying aircraft and/or safely landing aircraft, in one or more types of common, well-proven, or yet-to-be-developed, computer-automated modes. Similarly, the vehicle systems have one or more kinds of vehicle automating computers capable of safely operating vehicles, in one or more types of common, well-proven, or yet-to-be-developed, computer-automated modes. The system provides mechanical control linkage disabling means equipped with, or interfaced with, at least one control signal receiving means which is responsive to one or more wireless, or hard-wired, transmitted hijack-threat control signal(s) also referred to as a security-related control signal(s). Preferably, one or more control linkage disabling means are located within a series of physical control linkage components of a vehicle at a point subsequent to where manual control input is initiated and prior to where computer automated control is alternatively provided. When needed, the disabling means renders ineffectual the mechanical control needed for one or more humans to control or direct a vehicle such as an aircraft from the operative flight controls of that vehicle (aircraft). Other embodiments of the proposed invention include the employment of a similar control input disabling means approach for disabling human control of other vehicles capable of operating in one or more types of common, well-proven, or yet-to-be-developed, computer-automated modes. For example, ships and trains.

### BACKGROUND OF THE INVENTION

Following the horrific suicide-bombing attacks of Sep. 11, 2001, it became apparent that there was an urgent need to develop and implement ways to prevent such acts from ever happening again. Awareness that suicide-bombings might also be attempted with other modes of transportation such as ships and trains increased the need for solutions to prevent such attacks as well. Several new aircraft security systems, incorporating one or more types of computer flight automation were proposed that were intended to prevent terrorists from using commercial aircraft as ‘guided missiles.’ However, it was evident that such systems were better suited for an integration into a minority of aircraft having newer fly-by-wire ‘FBW’ technology and could not readily, or economically, be retrofitted to the majority of non-FBW equipped commercial aircraft, the latter of which numbered in the several of thousands. Employing automation for reliable control of FBW aircraft was not the problem, it was that non-FBW aircraft have physical linkage attached between their cockpits and their directional and speed controls and therefore the cockpit controls could override the control of the computer(s) or computer system(s) used for flight automation. This meant that, even though flight automation could effectively control these aircraft, one or more terrorists in a cockpit could still physically override the physical linkage to the non-FBW controls. Since government agencies such as the FAA or TSA were looking for solutions for both FBW and non-FBW aircraft, and the automation approach best served FBW planes, the proposed aircraft security systems seeking to use the advantages of computer automated modes of flight were not given much consideration by the aviation agencies or businesses, or the airlines.

Unfortunately, no aircraft security effort since 9/11, has proposed, or been able to claim a solution that achieves or comes close to, a ‘failsafe aircraft security’ solution to prevent repeat 9/11 types of suicide-bombing attacks with aircraft. Even the combination of newly proposed in-flight security approaches when combined with an effective implementation of one or more of the existing aircraft security components currently in use, no solution was offered that would approach a failsafe means for preventing 9/11 for both FBW and non-FBW aircraft. Similarly, 9/11 types of suicide-bombing attacks could be attempted with ships, or trains, carrying very large stores of volatile fuels or chemicals. The urgency of the need for a failsafe, or a closer-to-a-failsafe, approach has become more evident since 9/11 as reports were published citing suicide-bombing attacks being planned to take aim at nuclear power plants, and worse, at their significantly more vulnerable stores of spent fuel. There are 40,000 tons of spent fuel stored near reactors throughout the US, the spent fuel is five times more radioactive than the fuel used in the core of a nuclear reactor, and often stored in ‘corrugated buildings’ not ‘hardened’ reactor facilities. Such possible attacks included the ramming of a large fuel tanker ship e.g., with huge stores of LNG, into a reactor (the latter of which necessarily has to be located next to a large body of water).

Other flight automating alternatives for commercial aircraft had been proposed wherein aircraft would be diverted away from all strategic/military/socio-political and ‘symbolic’ (bridges, skyscrapers, stadiums etc.) targets along their respective flight paths. However, a cursory review of maps depicting such ‘targets’ illustrates the impracticality of such approaches. The flight management system ‘FMS’ (automated flight technology) was introduced primarily to provide significant savings in fuel. The FMS operating principle is that ‘the shortest path between two points is a straight line.’ With fuel costs being the single greatest expense of airlines, the prospect of directing aircraft around any or all significant targets along every commercial aircraft route would defeat the fuel cost-saving purpose of the FMS(s). While such ‘diverting systems’ are considered feasible under automated modes of flight, they have not included practicable means for disabling manual control input to the physical control linkage of thousands of non-FBW aircraft. It is the purpose of the present invention to provide control input disabling, and re-enabling means for both FBW and non-FBW aircraft and other vehicles, such as those mentioned previously.

Another attempted solution required external airframe alterations of commercial aircraft to install a camera and lens in the fuselage or wing of an aircraft for employment as a component of an object-recognition system intended to prevent suicide-bombing of aircraft at targets recognized by the system. However, this security concept would be unnecessarily costly due to required airframe alterations and would only be effective when an aircraft came within 3000 feet of an intended target. Since commercial aircraft routinely fly at altitudes that are more than ten times greater than 3000 feet, the system would require extreme altitude diversions before it would go into an effective automated mode. Such an approach could be quite frightening to passengers and still did not address the problem of one or more terrorists overriding the physical control linkage of non-FBW aircraft. Thus altitude and/or directional ‘diverting’ in-flight security systems would unnecessarily increase fuel expense, travel time and significantly reduce pilot control on a substantial number of flights.

By contrast, the vehicle suicide-bombing prevention system ‘VSBPS’ described herein and related systems described in co-pending patent applications, simply preclude any attempt to divert an aircraft if and when any hijack attempt is made or suspected, and the aircraft preferably remains on its most fuel-efficient FMS-programmed route, with the pilots retaining as much manual control of the aircraft as they like.

In addition to the employment of one or more flight automating computers to improve the security for aircraft having newer FBW systems, several other security approaches were attempted that were far from failsafe and that had limited value and considerable initial and/or ongoing costs. For example, nearly a half billion dollar budget was allocated for so-called ‘hardened cockpit doors.’ However, even a cursory analysis of the operation of commercial aircraft would have shown that these ‘hardened’ doors would be opened during millions of flights, i.e. millions of times, every year, for years to come. To illustrate this point, the following factors must be considered: (1) no commercial aircraft in operation today has a toilet in the cockpit, so pilots, co-pilots, and on larger aircraft flight engineers (up to 3-4 crew on the largest aircraft), must open their cockpit door to leave and open the door again to return following each and every restroom break; (2) meals and drinks are brought into and removed from the cockpit during flights (and many flights have multiple meal cycles); (3) by law, entire crews on flights over eight hours must leave the cockpit so that the replacement crew can then take over, and so on. These longer flights occur on aircraft carrying the most fuel, which is considered a chief criteria to the selection of aircraft by suicide-bombers. Thus, with millions of cockpit door openings occurring in flight every year, the hope of conjuring up a mental image in the mind of the flying public of some impenetrable bank vault door at a cockpit entrance, is an illusion. Rather, the reality of what actually occurs, conjures up more of an image of a ‘revolving door’ predictably and regularly opening, than it does an ‘impenetrable one’. Worse, the employment of hardened cockpit doors could actually backfire. For example, some pilots and co-pilots are women, and often the personnel authorized to ‘guard’ the cockpit when a member of the flight crew goes to the restroom, are also female flight attendants who can be quite small in physical stature. If one or more terrorists should decide to overtake a female flight crew member, or overpower the female flight attendant ‘cockpit guard’ first, then the female crew member, they can simply walk into the cockpit and lock themselves behind the safety of ‘an impenetrable door’ to wreak whatever havoc they choose for the remainder of the flight, or carry-out their suicide-bombing mission assured of no interruptions.

Some aircraft-security decision-makers proposed that flight crews should be equipped with handguns, but even a cursory consideration of this tactic, points out numerous shortcomings. Not the least of which is, that should this last-stand defense fail, the terrorist(s) win control of the aircraft. For example, in the scenario described immediately above, the remaining crew member still at the cockpit controls would be forced within just a second or two-presuming the terrorist(s) are smart enough to use the female flight crew member as a human shield—to shoot his own crew mate in an effort to keep one or more terrorists from entering through the opened door. Furthermore, any layout diagram, or photograph, of the flight crew's seating would show immediately that, when the pilot and co-pilot of a commercial aircraft seat themselves in the cockpit, they are well-committed to a forward-facing seated posture. Their legs are recessed into cavities having rudder controls and the pilots are separated by a large central console or pedestal. In some cockpit arrangements such as Boeing 777s (and others), the cockpit door can be located directly behind the captain and can also be located such that the door is not in plain view of the co-pilot. In many cockpits, the pilots' seats have to first be electrically positioned away from the console to allow the pilots enough room to turn and to get in or out. With their backs to their potential enemies and their legs necessarily in front of them pointing forward, the pilots are in no position to effectively defend or wage the definitive battle for control of an aircraft. Even if the cockpit door is aligned with the center of the aircraft, having to quickly aim a hand-gun or stun-gun with any accuracy, with one arm, 150 degrees behind one's seat is unrealistic. Shots fired by the pilot that miss their mark could easily hit innocent passengers or vulnerable parts of the aircraft. Many scenarios can be imagined that do not offer much hope of winning such a fight. If a cockpit is entered following predictable in-flight door-openings (as described above), the terrorist(s) will not slowly saunter in, the remaining pilot could realistically have less than two seconds to (1) find/draw his weapon, (2) release its safety, (3) correctly aim the handgun and fire it, assuming during this time the terrorist(s) would offer no resistance to the pilot's actions—with their two hands against his one. Such a short reaction time would be daunting even if the pilot was seated facing the cockpit door with nothing else to do, which, of course, is not likely. If there's a struggle for control of the gun, and rounds are fired which pierce the cabin, or a pressure dome, or vital avionics/electronics while the aircraft is flying in excess of 500 miles per hour, any number of catastrophic outcomes could result. If there's a de-pressurization of the cabin during the battle for control of the cockpit, the problems facing the flight crew compound. In any of the scenarios above, if the terrorist(s) gains control of the weapon used by a pilot or co-pilot, the terrorist(s) acquires a lethal weapon and the ultimate battle for complete control of the aircraft, is over. Reason would dictate that armed pilots literally are in no position to insist they must be an aircraft's final hope of defense—that the outcome of their shoot outs will be what ultimately determines the fate of an aircraft, all its passengers and worse, the fate of its intended suicide-bombing target. Thus a more dependable approach is needed. It is the object of the present invention to overcome the deficiencies of the prior art and to provide an economical and reliable system which can be easily adapted to FBW and non-FBW aircraft and vehicles.

Decades-proven flight and landing automation systems are regularly in use throughout the world, and the reliability of such systems can readily be employed to effectively dissuade, and counter, hijack or suicide-bombing attempts. Pilots, particularly in the hard-hit aviation economy of the US, need to take a honest look at the deficiencies of the current security methods in addressing the prevailing public perceptions and anxieties associated with the vulnerability of commercial aircraft to acts of terrorism. So long as aircraft security is not brought to a level that is significantly improved in the mind of the flying public, and the deficient status quo approach is used, the health of US aviation will remain in jeopardy.

One reason why proven flight and landing automation technology has not been given more serious consideration, is often identified with an illogical position maintained by the pilot's union ‘ALPA.’ Ignoring the fact, that for mere economic reasons (versus life-and-death aircraft security reasons) pilots readily forfeited about 60-70% of manual flight control to FMS flight control to save fuel, they appeared to be unwilling to sacrifice one ten-millionth more degree of ‘pilot control’ in order to save the lives of passengers, flight crews and those who would be in and around ground based ‘targets’ of suicide-bombers. The pilot's position is illogical because, it is based on the illusion of lost pilot control. Statistically speaking, 99.999999% of commercial pilots, over the entire course of their careers, will never experience a hijack attempt. Meaning, the same percentage of pilots will never be required to give up any further flight control to flight automation for security purposes. Hijackings, worst case, are in the order of a one in ten million probability, if no other actual, or perceived, improvement to aircraft security is implemented to further dissuade would-be suicide-bombers. Nonetheless, for the one in ten million flights having passengers and crew who must face such a horrific experience, having aircraft equipped to counter such scenarios by simply employing decades-proven and most common flight automation modes, remains the true logical alternative.

Some experts feel the pilot union needs to face the fact that so long as one or more crew member remains vulnerable to being overcome, and manual control of large aircraft having an equivalent of two large residential swimming pools filled with jet fuel can be commandeered, terrorists have an enormous incentive to win control of aircraft and use them as ‘guided missiles.’ If instead, it becomes public knowledge that aircraft are equipped, in the event of a suicide-bombing attempt, to safely fly and land using common and decades-proven automated flight and landing modes, terrorists would clearly have no hope of using aircraft as ‘guided-missiles’ at targets such as nuclear power plants, and have no incentive or reason to harm any flight crew, aircraft personnel or passengers. Moreover, they must consider that the only outcome they may achieve is a ‘hijacking of themselves’ (since an aircraft with the present system would simply land and be disabled until the suicide-bombers were removed). Presumably, the implementation, and wide-spread announcements of a vehicle suicide-bombing prevention system ‘VSBPS’, in combination with the other aircraft security measures already in use, would serve to further reduce, if not totally eliminate, hijacking rates. Meaning, pilots would have to concede to giving up control of far fewer than one in ten million flights—for life-and-death reasons—versus their present willingness to forfeit 60-70% pilot control for improved fuel economy. Such a concession (additional automation for one in ten, twenty or thirty million flights) is by any standard miniscule.

Pilots, and aircraft security related decision makers, would do well to consider that the first fully automated take off, cruise, landing and taxi to a full stop, by a four-engine plane, on a transatlantic flight was accomplished in 1947, using a C-54. The pilot observing the fully automated flight remarked to reporters in Europe that the flight culminated in “One of the smoothest landings” he had ever experienced. It is readily apparent that computer technology and flight automation have made significant advances, since the 1940's.

Tens of millions of hours of automated flight occur each year under FMS control, and probably over a million safe, fully automated landings have occurred since autoland systems were first implemented in the 1960's. Moreover, during regular fully automated landings for autoland certification, pilots are required to not interfere with the aircraft's controls during the automated landings. Confidentially, many pilots are willing to admit following monthly required auto-landings per aircraft, that the autoland system lands the aircraft better than the pilot can. Pilots also know that the thousands of commercial aircraft with autoland systems must regularly be certified each month, so they can be relied upon to perform fully automated landings under such poor visibility conditions that no safe pilot would dare attempt to control a plane.

A similar ‘hands-off’/automation-only requirement, is the norm for cutting edge military aircraft launched from aircraft carriers. Navy aircraft launch procedure, requires pilots to keep their hands off the controls of their aircraft until it has safely taken off and the flight automating computers let the pilot take over control of the aircraft.

Any forward-looking observer in the field of aviation can see that the future will bring more flight and landing automation capabilities, not less. Commercial US pilots who have resisted the integration of FBW technologies into US commercial aircraft, and fail to advocate any substantive change to the status quo approach to aircraft security, may well see their aircraft and their jobs going more and more to foreign companies and foreign pilots who readily embraced the newer technologies. Today, US aviation agencies and US aviation businesses stand at the juncture of where innovation and technology, versus contentment with a status quo approach, may well determine the very survivability of US commercial aviation.

Meanwhile, guns, knives and explosives have continued to get past airport screeners, and thousands of security breaches that could have allowed easy access to aircraft openings other than the passenger cabin door, have occurred in recent years. Under such security breaches, guns, knives and explosives (or other weapons) don't have to even go past screeners, to end up on aircraft.

So long as aircraft, ship or train commandeerings remain possible, terrorists will be motivated and conniving enough to seek very unconventional ways to accomplish horrific acts. Unfortunately, plausible non-conventional approaches still remain possible but it would not be appropriate to published such scenarios in this document. The point is that cockpits of commercial aircraft and those of ships and trains have been, and remain, vulnerable, so long as (1) pilots insist they'll be what determines the final line of defense of aircraft and intended ground ‘targets’ and (2) security decision makers insist that status quo security approaches will suffice. How vulnerable are aircraft and terrorist-planned targets such as nuclear power plants? When the former FAA security chief Billie Vincent, president of Aerospace Services International, was asked for his opinion about aircraft security months after the 9/11 attacks he said, “We have not done any appreciable thing yet that would prevent another September 11 tragedy. Should we feel more comfortable? No.”

Such realizations, including the prospects of air attacks on vulnerable nuclear power plants have produced unthinkable new proposals. Because all aircraft security systems proposed to date are focused at what happens before a successful hijacking occurs and provide no recourse thereafter, U.S. fighter jet pilots have been told to be prepared to do the unthinkable: shoot down commandeered airliners full of innocent passengers.

In contrast, the present VSBPS is designed to provide automated control of fly-by-wire ‘FBW’ and non-FBW aircraft, as soon as any hijacking is either suspected or attempted, or when a substantiated threat to any flight personnel or passengers is suspected or made, thus eliminating the proposed military solution of scrambling fighters to shoot down commercial aircraft.

Thus, there is a need for a technology which addresses the deficiencies, economic consequences and remaining security vulnerabilities of (1) the prior art, and (2) the status quo aircraft security approaches described above.

It is the object of the present invention to provide the means for economically, and practicably, achieving a failsafe system for preventing the suicide-bombing of commercial aircraft'. Other significant objects of the invention, in combination with the technologies taught in the cross-referenced co-pending provisional, and non-provisional patents, include, but are not limited to:
To create the first failsafe aircraft security program by combining the VSBPS with an effective implementation of the existing aircraft security components currently in use.
To prevent suicide-bombings of VSBPS-equipped commercial aircraft (as well as VSBPS-equipped ships and trains).
To provide a VSBPS which is equipped to simply link the two most commonly and regularly used modes of automated flight (cruise [or autopilot] and autoland).
To provide a VSBPS which includes public announcement means to announce to all passengers before boarding, and before an aircraft departs, that the plane is equipped with a Flight Management and Autoland system ‘FMAS’, of a type, that logs millions of hours of automated flight every year, and has logged approximately one million safe, fully automated landings and that the aircraft is equipped to be instantly placed in a safe automated flight mode if any attempt to overtake the plane, or any attempt to harm anyone aboard the aircraft is made or suspected.
To eliminate terrorists' incentive to hijack, or do harm to flight crew, flight personnel and passengers.
To provide a VSBPS wherein attempted hijackings result in hijackers ‘hijacking themselves.’
To provide a VSBPS wherein aircraft landed after a hijack threat remain flight-disabled until all threats and all people are removed from the plane, and until authorized security personnel board the plane and reset the VSBPS to an enabled state.
To preserve maximum fuel-saving benefits of FMS's and Autoland efficiencies on all flights
To provide a VSBPS that is minimally intrusive to pilot control, statistically not having greater than a 1/10,000,000th increase to the total amount of U.S. automated flight per year (estimate).
To optionally provide surface mounted transmitters/HJT buttons within reach of pilots (e.g. on control yoke).
To provide several ‘false deployment’ reset procedures during flight (procedures are simple and quick).
To return full, normal control of aircraft immediately to pilots after any false deployment procedure is completed.
To provide secure facility oversight, false deployment resetting options, and other security options.
To provide a VSBPS wherein ATC is informed of all pertinent aircraft I.D., location, altitude, flight-path, and destination information upon any HJT to an aircraft.
To eliminate the need for pilots to fight ‘last gun battle’ for control of cockpit. To eliminate the need to install impenetrable cockpit doors on all commercial planes in US ($500,000,000 budgeted) doors that will otherwise be opened millions of times per year, during millions of flights, for years to come.
To prohibit terrorists from locking themselves in the safety of a cockpit behind a $30,000 impenetrable door.
To provide the potential to eliminate the need for legions of air marshals and their salaries and benefits of (hundreds of millions of dollars, every year est.).
To eliminate the hazards of cockpit gun battles, and the firings of air marshal handguns, and aircraft depressurizations or catastrophic structural damage caused by bullet piercings of aircraft flying at speeds in excess of 500 MPH.
To provide FMS software routines suitable for controlling lower altitude automated flight mode(s) if HJT-related cabin depressurization should occur.
To eliminate military's plan to shoot down hijacked commercial aircraft full of passengers (by eliminating the possibility of suicide-bombings).
To provide manual vehicle control input disabling and enabling means including means for economically, reliably and safely disabling and re-enabling the flight controls of commercial aircraft that have fly-by-wire ‘FBW’, partial FBW, or no FBW capabilities.
To provide a simple and economical VSBPS comprised mostly of existing, or minimally modified, aircraft control linkage parts and minimal actuation thereof, using proven aircraft control part actuators, only in the event of a HJT, and provide small secure-signal transmitter means for safely, reliably and anonymously transmitting one or more HJT, or reset signals to one or more receivers.
To provide a VSBPS wherein no expensive alterations of aircraft airframes are required. To provide a VSBPS wherein no diverting of an aircraft from normal flight procedures is required.
To provide a VSBPS wherein passengers experience VSBPS-controlled flight as a normal flight.
To provide an onboard security approach that is non-confrontational, non-combative. To provide HJT transmitters employing proven, off-the-shelf secure, communications technology.
To provide a VSBPS wherein HJT transmitters are easily upgradeable as voice, video and encryption technologies advance, and voice-stress analysis, voice-recognition, image-recognition technologies can be readily accommodated.
To provide a VSBPS wherein carried transmitters are as easy to operate as a garage door-opener.
To provide a VSBPS wherein surface mounted transmitters are as easy to use as a typical fire alarm, or as easy to use as dialing ‘911’ using an onboard aircraft-provided cell phone.
To provide a firm ‘triple-tap’ deployment procedure of recessed transmitter buttons to preclude accidental bumping or other false deployments.
To provide transmitter redundancy on an aircraft ranging from several transmitters, to scores of transmitters by use of GTE Airfones.
To create a psychologically beneficial “Neighborhood Watch” kind of community safeguarding effort and increased security awareness on any and all flights.
To provide a VSBPS having optional roll-out stages wherein a first stage requires minimal hardware changes comprising a communications link between an VSBPS receiver and the operative automated flight computer(s) and mostly software updating; a second stage provides portable, anonymously concealed transmitters, and a third stage provides evolving degrees of interactive communications between aircraft and one or more secure facilities.
To provide security alternatives for alleged, or substantiated, chemical, biological or nuclear weapon threat on aircraft.
To provide optional non-combative method for incapacitating hostile terrorists immediately after a VSBPS-equipped plane has made an automated landing.
To provide a way to keep commercial aircraft away from strategic, political, military and economic targets, and keep planes away from buildings and allow architects and developers to return to their building of impressive high-rises.
To assist in restoring investor confidence in commercial buildings.
To reduce the insurance overhead for airlines, high-rise buildings, power plants, dams and other infrastructure.
To assist in restoring the flying public's confidence in commercial aviation.
To assist in restoring investor confidence in commercial aviation (economic recovery tied to security confidence level)
To assist in restoring confidence in the perception that the U.S. economy is under America's control, not under the terrorists' control.
To level the playing field for integrating VSBPS in both non-FBW and FBW-equipped aircraft, so that FBW aircraft manufacturers do not have an unfair advantage in achieving an aircraft security competitive advantage over manufacturers of aircraft without FBW systems.
To provide a tangible, economical and practical means for improving a deficient, status quo aviation security program.

### SUMMARY OF THE INVENTION

In co-pending patents, embodiments of a failsafe system for preventing the suicide-bombing of commercial aircraft (and other vehicles) are described wherein one or more authorized personnel aboard a vehicle can transmit a wireless or hard-wired signal to one or more receivers interfaced with the vehicle's computer(s), or computer system(s), wherein the computer(s) or system(s) are integrated into the vehicle for safely operating the vehicle in one or more fully automated transportation modes. For the sake of brevity, the system will be referred to hereafter as a vehicle suicide-bombing prevention system abbreviated ‘VSBPS.’ The co-pending ‘hijack disabling system’ takes advantage of the fact that a substantial number of commercial aircraft are already equipped with decades-proven flight and landing automating systems that have reliably provided hundreds of millions of hours of automated cruise and well over a million fully automated landings (the latter achieved through regularly scheduled autoland certification procedures and CAT-3 landings). The co-pending technology and the present invention also provide several means for quickly returning full control of a vehicle back to its authorized crew in the event that (1) a security-related signal such as a hijack threat signal (hereinafter referred to as ‘HJT’ signal), is transmitted in error causing a false deployment, or (2) if a legitimate HJT event has subsequently been subdued or overcome and, in either case, it is deemed safe, by one or more authorized crew member, such as a pilot in command, to return control of the vehicle back to that crew. In such cases, with aircraft for example, the VSBPS can be equipped to closely monitor the operation and control of the aircraft within acceptable and predetermined limits, and place the plane immediately back into a HJT mode automatically if the plane exceeds the acceptable limits. Alternatively, or additionally, one or more authorized personnel aboard the plane can send a subsequent HIT signal via a wireless or hard-wired transmitter if any additional HJT is suspected, or encountered.

The vehicle suicide-bombing prevention system ‘VSBPS’ of the present invention, when combined with the security measures currently in place for transportation vehicles such as aircraft, ships and trains, provides a failsafe, or nearest-to-failsafe, system for preventing the suicide-bombing of a vehicle equipped with one or more onboard computer(s) or computer system(s) capable of operating the vehicle in an automated transportational mode along, or to the end of, one or more paths, flight paths, flight vectors, glide slopes, landing approaches, runways, taxi path(s), shipping lanes, or rails of railroad systems, and the like.

The system is comprised of one or more vehicle control input disabling means which disables human, or manual, control input from the cockpit of an aircraft, or piloting location aboard a ship or locomotive when one or more hijack threat control signals, indicating a suspected, or actual hijack threat, is received by one or more receivers of the system. The disabling of human (manual) control input on a vehicle takes place after a point where human control input is initiated and before a point where control can be provided by one or more computer(s), or computer system(s) capable of operating the vehicle in one or more automated transportation modes.

When a hijack threat ‘HJT’ occurs, or is suspected, on vehicles not having, or having a minimal degree of, FBW control, the system has one or more control input disabling means which are equipped to be responsive to control signal communicated by one or more vehicle automated control computer(s), computer system(s), or sensors, to adjust the physical linkage of one or more vehicle control means to a degree that human/manual input is ineffectual or completely disabled.

When a HJT occurs, or is suspected, on vehicles having FBW control systems, the system has one or more control input disabling means which are equipped to be responsive to control signal communicated by one or more vehicle automated control computer(s), computer system(s) or sensors, to disable one or more vehicle FBW control means to a degree that human/manual input is ineffectual or completely disabled.

In each embodiment, the system preferably provides the means, during a vehicle's operation, to promptly return the disabling means to a state where human/manual control of the vehicle is allowed. For example, following a false deployment of the system, or if a HJT is successfully subdued while the vehicle is still in transit, and one or more authorized personnel aboard the vehicle e.g., a pilot in command, subsequently determines that resetting the system is safe, then, the system's enabling means promptly returns the full control of the vehicle back to its crew.

On vehicles with no, or minimal, FBW control, vehicle control input disabling means can be positioned within a vehicle's physical control linkage at one or more positions subsequent to the point of where human/manual input is initiated and prior to a point where one or more automating computers, or computer systems, is positioned to control the vehicle in one or more automated transportation modes. For example, with the elevator control of an aircraft where cable control and/or hydraulic control is employed, the input disabling means could be positioned adjacent to the lower end of the elevator control yoke beneath the cockpit floorboard, or can be positioned at an end of, or on, or near to, a control member, such as torque tube, rotational drum, quadrant, quadrant sector, pulley and the like, or can be positioned along the length of the control cable, or push-pull tube or rod, or other physical linkage, or can include the selective control of pressure effecting hydraulic or pneumatic apparatus, and so forth. In each case, the control disabling occurs in the physical linkage or components, before a point where the input from the automated control components of the aircraft occurs. Thus, each disabling means is positioned post-pilot input but pre-computer automated input. For example, if one or more control disabling means are employed to elongate an elevator control cable, or decrease hydraulic pressure of one actuator or pump, to the point where a pilot can no longer manually input effective elevator control, such adjustments are made at a point in the physical linkage of the elevator control before those elevator adjusting components that are responsive to the aircraft's automated elevator control. Thus, subsequently positioned automated elevator control components (further from the pilot input controls) remain normally active under the control of one or more proven automated systems while the previous physical linkage (closer to the pilot input controls) is disabled, and the aircraft flies in one or more reliable automated modes while the cockpit control input is disabled.

Preferably, the manual control input disabling and enabling means, effecting the physical control linkage and/or components of a vehicle employ, existing, or minimally modified, manual vehicle control input parts and include the option to position one or more of such parts in a minimal manner wherein adjustments made by one or more actuators of only a fraction of an inch are sufficient to disable, or re-enable, a given vehicle control.

The control disabling means and enabling means can be employed on non-FBW, partially FBW-equipped and FBW-equipped vehicles, to selectively disable or re-enable the control of vehicle control means including, but not limited to: elevator control, rudder control, aileron control, spoiler control, trim control, FMS input, FMC input, flight automating input from a button, keypad, keyboard, or microphone to one or more computer(s) or computer system(s), and control of engine speed, flap settings, brake settings, and the like.

Computer(s) or computer system(s) of the VSBPS can also be pre-programmed to fly in an automated mode at a safe altitude and along one or more safe route in the event of a cabin depressurization.

Preferably each manual control input disabling and enabling means employed on a given vehicle is configured in a normally-on/enabled and safe operative state and equipped with redundant means to activate and deactivate the disabling means, and only in the extremely rare event of an actual, or attempted hijacking, or commandeering of the vehicle, is the disabling means changed from its normally-on/enabled or safe operative state to a manual control input disabling state. For example, if a disabling means employs a lead-screw adjustment means driven by an electromechanical rotational device, the lead-screw's normally-on state will be a reliable and safe un-rotated condition and only when a HJT is encountered—statistically no more than a one in ten million occurrence—will the lead screw(s) then be rotated to a disabled state. A similar normally-on reliable and safe condition and redundancies can be achieved with one or more of, or any combination of, the following: hydraulic apparatus, or pneumatic apparatus, or electrically controlled, or electronically controlled, or electrostatically controlled, or computer-controllable, or microprocessor-controllable, actuators, linear actuators, solenoids, switches, connectors, tensioners, locking apparatus, motors, stepper motors, servos, diaphragm-actuating, piezo component, and so on. Additionally, actuators employed for controlling disabled or enabled state changes can be of a type that require no current, or pressurization, to maintain, or retain, a disabled or enabled state.

When the VSBPS employs a lead screw driven by a motor, stepper motor, or servo as an adjustment means to adjust the effective length a control cable, or to position another type of physical control member, to a disabling state, another, redundant arrangement of a lead screw driven by a motor, stepper motor, or servo can also be provided in the event that the first disabling means arrangement should fail to cause a desired disabling condition. Conversely, if the VSBPS employs a lead screw driven by a motor, stepper motor, or servo as an adjustment means to tighten a control cable back to its normal operative length, or to position another type of physical linkage control member, to a normally-on, enabled and operative state, a redundant arrangement of a lead screw driven by a motor, stepper motor, or servo can also be provided in the event that the first re-enabling means arrangement should fail to cause a desired re-enabled condition.

Similarly, if apparatus employing hydraulic, or pneumatic, pressure are used as a control input disabling and re-enabling adjustment means, another redundant adjustment means can be used in combination, or a similar disabling and re-enabling means arrangement of apparatus employing hydraulic, or pneumatic, pressure, can also be provided in the event that the first disabling and/or re-enabling means arrangement should fail. In the unlikely event that redundant adjustment means should fail to disable human/manual control of one of a vehicle's controls, the VSBPS allows for a plurality of disabling means to be positioned serially such that another adjustment means preferably having redundant actuators can be deployed to disable that control. Similarly, if a first disabling means having redundant adjustment means should fail to re-enable human/manual control of one of a vehicle's controls, the VSBPS allows for a plurality of re-enabling means to be positioned serially such that another re-enabling means preferably having redundant actuators can be deployed to re-enable that control. If all re-enabling means should fail, the VSBPS deployment of the vehicle's normal automated control system will merely continue to operate in a typical automated manner safely concluding the vehicle's journey.

Thus, when one or more receivers interfaced with the VSBPS computer(s) receives at least one transmittable HIT-related signal, at least one VSBPS software routine is then implemented which causes the computer(s) to operate the vehicle in at least one automated mode. The VSBPS computer(s) transmit at least one control signal to the vehicle's control disabling means which, in turn, adjusts vehicle control linkage attached thereto to a degree where mechanically linked vehicle control input of the vehicle is ineffectual.

The apparatus includes mechanical control linkage disabling means equipped with, or interfaced with, at least one control signal receiving means which is responsive to one or more wireless, or hard-wired, transmitted hijack-threat control signals. The control linkage disabling means is configured to eliminate mechanical control necessary for one or more humans to control or direct a vehicle e.g., an aircraft from the flight controls of that aircraft.

Other embodiments of the proposed invention include the employment of a similar control input disabling means approach for disabling human control of other vehicles capable of operating in one or more types of common, well-proven, or yet-to-be-developed, computer-automated modes, for example, ships and trains.

In the case of VSBPS-equipped aircraft, any one or more in a variety of currently available, or yet-to-be-developed flight automating computers, or flight automating computer system(s) can be employed. In any case, one or more computer(s) or computer system(s) have the capability to automate any one or more in a variety of predetermined or programmable flight paths, or vectors, or change from one location, position, altitude, attitude, path, course, glide-slope, descent or vector to one or more of another. When the computer systems of the VSBPS also include autoland capability, such aircraft are equipped to descend and safely land in an automated mode at airports also having an autoland ground-based system. Thus, transitioning from a autopilot controlled cruise phase of flight into a glide-slope of an autoland controlled phase of flight is also provided. In the case, for example, autoland certification procedures require that autoland equipped aircraft regularly land in a fully automated mode

The vehicle suicide-bombing prevention system (VSBPS) can optionally be rolled out effectively and in an economically optimized manner, in three successive stages. This approach allows for an almost immediate first stage VSBPS deployment, requiring little or no hardware changes or hardware additions. A second stage equips vehicles with one or more economical type of transmitters which provide authorized vehicle personnel, other than those at the vehicle controls, to immediately and anonymously place a vehicle in one or more safe automated transportation modes. The third stage provides for communications and evolving communications deployment and interactivity between a vehicle and one or more secure facility.

For example, in a first-stage approach with aircraft, having fly-by-wire ‘FBW’ capabilities, only modification of the flight automating software and minimal changes to computer I/O, or computer system I/O, capabilities is required. With FBW aircraft, the VSBPS has a communications link with the operative flight and landing automating computer(s) or computer system(s) of the aircraft and executes, as needed, one or more common automated modes of flight while also disabling FBW flight control input from the cockpit. Non-FBW aircraft can also benefit from the three-stage rollout approach but must also have VSBPS hardware modifications to selectively disable the physical control linkage connected with the operative cockpit controls.

In this first of three optional roll-out stages of the VSBPS, the system is made economically and rapidly-deployable by the relatively simple addition of software routines to existing flight and landing automating computer(s) or computer system(s). For example, in the case of an aircraft having one or more computer(s) for automating cruise phases of flight, and an autoland system for automating landing phases of flight, the VSBPS and software is responsive to one or more hijack threat ‘HJT’ signals and combines the pre-programmed cruise and autoland phases of flight (the two most common, proven automated modes of flight). As described above, the automated cruise phase would end with an appropriate glide-slope into the automated autoland phase.

In the simplest variant, the HJT signal is initiated by a button accessible to a pilot and/or co-pilot, and/or engineer. The button can optionally be an Autopilot Initiate/Release button on the control yoke, or a pre-determined interface button of an FMS or other proximate device. To prevent accidental activation of the VSBPS, a software routine of the system preferably requires that the operative button be pushed several times in rapid succession within a pre-determined time limit (for example, 34 times within 1.5 seconds) for the system to recognize that a HJT control signal has been sent.

Alternatively, or additionally, vehicles can be equipped with one or more manual vehicle control input monitoring means which has sensors to continuously monitor manual control input to the input controls of the vehicle relative to its current transportation mode. For example, with aircraft, the monitoring means can monitor manual control input from within a cockpit relative to the current flight mode, aircraft attitude, location and altitude, and with the VSBPS being equipped to transmit a HJT signal when the type of input is not within, or exceeds a predetermined acceptable and/or authorized degree of input for that phase of flight. Preferably, the system can cross-reference the control input relative to a current flight phase, vehicle conditions and navigational feedback from GPS avionics and/or data, or other in-flight location and altitude determining means. In the event of a monitored cabin depressurization, or other in-flight emergency, the monitoring means allows predetermined flight control input within an acceptable range of control input for safely descending to an appropriate altitude from the then current location, attitude and flight phase of the aircraft. Upon receipt of a HJT signal, a hijack transponder code is preferably transmitted from the aircraft to air traffic control ‘ATC’ and the aircraft is granted a priority clearance status to complete an automated cruise phase to, and an automated landing at (A) the originally scheduled autoland-system-equipped destination-airport, or (B) can be diverted along one or more FMS pre-programmed/acceptable flight paths to a closer or alternate airport equipped to handle automated landings. Following the reception of one or more HJT control signals, the VSBPS (1) disables manual inputting of commands or data into the operative flight automating computer(s) or computer system(s), and (2) manual input to the cockpit flight controls is also disabled, locked or limited, such that the aircraft can only fly in (or within a predetermined proximity to) authorized automated cruise/landing modes to one or more destinations pre-programmed into the computer(s) or computer system(s). Security codes specific to acceptable/authorized VSBPS flight paths and modes can be required before being input into an FMS preferably before a plane departs. This software-only stage of a VSBPS (optionally with minimal hardware changes) provides the psychological impact and benefit of a functioning VSBPS, albeit on a first-stage level. The first-stage approach has less false-deployment reset flexibility, than second and third stages, nonetheless in a worst-case HJT scenario (without a false deployment reset procedure) the aircraft with this VSBPS stage merely flies in its automated mode(s), with priority status, to a pre-programmed autoland-equipped, or other automated landing-equipped airport.

With an implementation of any of the three VSBPS stages, a psychological benefit/impact is also provided, wherein terrorists are deprived of knowing which, if any, of the three VSBPS stages is operative (including whether or not the aircraft has any VSBPS stage at all). Thus early announcements of a VSBPS rollout can have an immediate, powerful impact on preventing aircraft (and train or ship) suicide-bombings.

In a second-stage variant of a VSBPS three-stage roll-out, the system can include any or all of the features and benefits of the first-stage but also provides relatively inexpensive hardware, including transmitters that are equipped to communicate with receivers, with the latter interfaced with the operative flight and landing automating computers of an aircraft (or other vehicle) to receive secure and/or encrypted HJT control signal sent from one or more transmitters. Optionally, the transmitter(s) and/or receiver(s) of the system can be transceivers. In one approach, the transmitters or transceivers are equipped for wireless communication and are compact, easily carried, transported and can be anonymously concealed, preferably having a activating button that is sized for easy activation and is quickly and easily located by touch. The VSBPS activating button of the transmitters or transceivers can be recessed to avoid accidental bumping, and require a plurality of firm taps within a predetermined timeframe e.g., 3-4 quick taps within 1-1.5 seconds to send a HJT signal. The transmitter(s), receiver(s), or transceivers send and receive secure and/or encrypted signal and can also be equipped to require that signals be sent and received using a rolling code so that no transmission is monitorable and replicable, each signal-transmission has its own unique, matching encoding and decoding code. For example, one technology employed by the garage door opener manufacturer “Genie®” uses a rolling code wherein signal sent between a compact handheld transmitter and received by a receiver located in a garage, provides four billion unique rolling codes before any signal-code would be repeated. Such transmitters, less than two inches square in size, are lightweight and can be carried anonymously by one or more authorized flight personnel (crew, attendants and/or air marshal) in the pocket of pants, a jacket, a shirt, a dress, a blouse, and the like, and have sufficient transmitting power to transmit signal from within that pocket to one or more receivers at ranges easily exceeding the length of the largest commercial aircraft. This communication hardware is well-proven and inexpensive.

The VSBPS can easily accommodate anywhere from one to a hundred or more hijack threat HJT transmitters on an aircraft. In an optimal approach, preferably all authorized flight personnel carry or have immediate access to a transmitter. For example, on a full 747 flight, each flight attendant (8+), each flight crew member (2-4), and each flight marshal (1-2) carry or have easy access to nearby easy-to-use transmitters. In the cockpit, the transmitters can alternatively be surface mounted in close proximity to the pilots' hands. In each case, the vehicle automated control system ‘VACS’ is equipped to receive any signal sent from one or more transmitters and to place an aircraft in an automated flight condition when that signal is received.

In another approach, surface mounted transmitters, wireless or hard-wired, can optionally be mounted within the passenger cabins of aircraft for easy access to flight personnel and/or passengers. In the latter case, flight attendants can announce before each departure where the emergency alarms are located throughout the aircraft and restate that activating any one or more of them places the aircraft in a protected, fully automated safe flight mode. The surface mounted alarms can have the appearance of, and the same easy/familiar operation as, a typical wall-mounted fire alarm. This security approach, in effect, creates a ‘Neighborhood Watch’ on aircraft, which behaviorists say is effective in increasing security confidence levels, and engages the watchful eyes of, and empowers, all passengers. Various false deployment procedures are described below which can return full control of an aircraft immediately to its crew when a HJT signal is incorrectly or mistakenly transmitted, or an actual threat is successfully thwarted.

In its fullest form of transmitter accessibility, the VSBPS puts every seated passenger within instant reach of their own ‘built-in’ surface mounted alarm system. For example, in-flight cell phones, such as the “GTE Airfone” are already installed by the scores on the back of passenger seats on many commercial aircraft. In this embodiment of surface mounted transmitters, the cell phones are equipped to transmit a HJT signal following the input of a pre-determined series of entered numbers. For example, when pressing the easy-to-remember numbers “9-1-1” on the Airfone dialpad, the phone instantly transmits a HJT signal without requiring any prerequisite step, such as the entry of credit card information. Optionally, the seat number and name of the dialer is also transmitted and recorded. Passengers are informed that they are empowered to send an HJT signal but the intentional sending of a false alarm signal, for any reason other than a legitimate hijack threat, is a federal crime and is punishable by fines and/or imprisonment, much like falsely yelling “Fire!” in an enclosed building. As technology advances, the VSBPS is designed to easily accommodate the use of transmitters, or Airfones, also having unidirectional, or bi-directional, voice, or voice and video, communications between the passenger cabin and cockpit.

### BRIEF DESCRIPTION OF THE DRAWINGS

FIG. 1 diagrammatically depicts the relationship of components in embodiments of a vehicle suicide-bombing prevention system ‘VSBPS,’ for example, a commercial aircraft, ship or train. In any of the embodiments, a vehicle automated control system VACS is equipped to receive and is responsive to a one or more security-related signals. Components shown enclosed in a dashed-line rectangle (upper right) are employed by embodiments of the invention providing means for manually transmitting hijack threat signals to the system. Components shown enclosed in a dashed-line polygon (lower right) are employed by embodiments of the invention providing means for interactivity between a vehicle and one or more secure facilities.

FIGS. 2A and 2B diagrammatically depict the relationship of a manual control input disabling and re-enabling means which is positioned after manual vehicle control input means and before computer automated vehicle control means. In FIG. 2A, manual vehicle control input is shown enabled to control vehicle direction and speed. In FIG. 2B, manual vehicle control input is shown disabled and computer automated vehicle control means controls vehicle direction and speed. FIG. 2B also depicts a system reset procedure for re-enabling manual control of the vehicle.

FIGS. 3A and 3B diagrammatically depict the relationship of a manual control input disabling and re-enabling means which is positioned after manual vehicle control input means and before computer automated vehicle control means of a FBW-equipped vehicle. In FIG. 3A, manual vehicle control input is shown enabled to control vehicle direction and speed manually. In FIG. 3B manual vehicle control input is shown disabled and computer automated vehicle control means controls vehicle direction and speed. FIG. 3B also depicts a system reset procedure for re-enabling manual control of the vehicle.

FIG. 4 diagrammatically depicts the side view of a variety of components commonly used in the physical control linkage of vehicles such as aircraft, ships and trains and identifies several locations within the linkage, after manual control is initiated and before computer automated vehicle control means controls a vehicle, where one or more component control means can be selectively disabled, or re-enabled, without restricting the automated control of the vehicle.

FIGS. 5A and 5B are cross-sectional side views of control means for selectively disabling and re-enabling vehicle control linkage, comprising a push-pull member such as a push-pull tube or rod slideably positioned within another tube, wherein an actuator member interacts with the inner tube or rod to enable or disable the sliding of the tube or rod within the outer tube.

FIGS. 6A and 6B are partial cross-sectional side views of control means for selectively disabling and re-enabling vehicle control linkage, comprising a torque tube or rod rotatably positioned within a sleeve with the tube or rod having a control arm attached to an end thereof, wherein an actuator member interacts with the torque tube or rod to enable or disable the rotation of the tube or rod within the sleeve.

FIG. 7A depicts the side view of vehicle control linkage components including a push tube or rod, or push-pull tube or rod, operative within one or more push-pull member locking means. FIG. 7A also depicts side views of control arms each of which can be disabled, or re-enabled, by control means illustrated in FIGS. 8-13.

FIGS. 7B and 7C are partial cross-sectional side views of control means for selectively disabling and re-enabling vehicle control linkage, comprising a push-pull member, such as a push-pull tube or rod which is slideably positioned within a tube or rod sleeve, wherein an actuator member interacts with the inner tube or rod to disable (7B) or enable (7C) the sliding of the tube or rod within the sleeve. Optionally, the actuator control means can be pivotably mounted on other control linkage of a vehicle.

FIGS. 8A and 8B are partial cross-sectional side views of control means for selectively disabling and re-enabling vehicle control linkage, comprising a torque tube or rod having a control arm rotatably positioned at an end thereof, wherein an actuator member interacts with the control arm to enable (8A) or disable (8B) the rotation of the arm at the end of the tube or rod.

FIG. 9 is an exploded three-dimensional illustration of adjoining torque tube parts commonly employed at the lower end of control columns used on commercial aircraft such as Boeing® 747's. The conventional tube parts are made with interlocking ends, such that when the parts are fastened together, forward and aft movement of the control column, causes the elevator control arm attached at the end of a torque tube, and control linkage attached thereto, to move in response to the movement of the column. Below the control column, an aileron pulley is shown, which, optionally can have an interlocking upper surface that is made to interfit with a corresponding interlocking lower end surface of the control column, such that when the parts are fastened together, aileron control yoke input causes the drum attached at the end of the control column, and control linkage attached thereto, to move in response to the input of the yoke.

FIG. 10 is a side view of a torque tube section at the end of a control column, wherein an end of the tube has a male interlocking member which slideably fits within a corresponding female interlocking member located adjacent to a control arm member. The combination of the control arm and female interlocking member are positionable over the male interlocking member by one or more linear actuating means.

FIGS. 11A, 11B and 11C illustrate three end views of the interlocking male and female members depicted in FIG. 10. FIG. 11A is an end view of the male interlocking member which slideably fits within the female interlocking contour of a torque tube or rod depicted in the end view of 11B. FIG. 11C shows the interfacing of the male and female interlocking contours.

FIGS. 12A, 12B, 13A and 13B are side views of a torque tube such as the type found at the end of a control column of a commercial aircraft, wherein an end of the tube has an interlocking surface which interfits with a corresponding female interlocking surface formed adjacent to a control arm member. The combination of the control arm and female interlocking surface is positionable by one or more linear actuating means to, (1) interfit and lock with, or (2) be separated and unlocked from, the male interlocking surface. FIG. 12B depicts the enabled control input components of FIG. 12A in a disabled state. FIG. 13B depicts the enabled control input components of FIG. 13A in a disabled state.

FIGS. 14A and 14B are side views showing the lower end of a control column having a male spline and shaft which is positionable by one or more linear actuators into and out of a central aperture and female spline of a rotational drum, or pulley. The rotational drum, or pulley, is shown in a cross-section.

FIGS. 15A and 15B depict the side view of a control quadrant, or quadrant sector, having a low-profile male interlocking surface which is co-axially aligned with and interfits with a respective female interlocking surface formed adjacent to a control arm member. The combination of the control arm and female interlocking surface is positionable by one or more linear actuators to, (1) interfit and lock with, or (2) be separated and unlocked from, the male interlocking surface.

FIG. 16A is a three-dimensional illustration of a manual control linkage adjustment means commonly employed on commercial aircraft such as Boeing® 747's. The apparatus typically serves as a control quadrant cable-tension regulator, or tensioner. In FIG. 16B, a similar apparatus is equipped with rotational drive means to rotate lead screws to disable or re-enable manual quadrant input, depending on whether the cable tension is slackened, or regulated for normal operation, by the apparatus.

FIGS. 17A and 17B are side views of a jointed manual control input member, such as a control column, having at least one linear actuator pivotably mounted thereto which controls the angle of a lower control member relative to the angle of an upper control member and provides a range of adjustment suitable for disabling and re-enabling normal manual control input to the control column. The upper end of the lower member is shown having an optional locking means.

FIGS. 18A and 18B are side views of a jointed manual control input member, such as a bell crank, having at least one linear actuator pivotably mounted thereto which controls the angle of a first control arm member relative to the angle of a second control arm member and solely, or in combination with other adjustment means, provides a range of adjustment suitable for disabling and re-enabling normal manual control input to the bell crank.

FIGS. 19A and 19B are side views of a jointed manual control input member, such as a bell crank, shown having at least one hydraulic, pneumatic or solenoid-driven linear actuator pivotably mounted thereto which controls the angle of a first control arm member relative to the angle of a second control arm member and solely, or in combination with other adjustment means, provides a range of adjustment suitable for disabling and re-enabling normal manual control input to the bell crank.

FIGS. 20A and 20B are side views of a physical linkage connecting apparatus for transferring the manual control input received by a first member, through at least one hydraulic, pneumatic or solenoid-driven linear actuator pivotably mounted thereto, to a similarly configured second member. The linear actuator(s) controls the angle of a first control arm member relative to the angle of a second control arm member and solely, or in combination with other adjustment means, provides a range of adjustment suitable for disabling and re-enabling normal manual control input to the control linkage.

The side views of FIGS. 21A, 21B, and top views of FIGS. 22A and 22B illustrate linear actuators pivotably mounted near to the end of a manual control input arm, or member. Each actuator has a lead screw driven by rotational drive means such as a stepper motor, motor or servo. Rotation of the lead screws positions a carriage which in turn, adjusts the length of control linkage attached to. In FIG. 22D, a rotational transmission means such as a belt or chain couples the rotation of motor pullies or sprockets to provide rotational drive means redundancy.

The side views of FIGS. 23A, 23B, 24A and 24B illustrate linear actuators configured for adjusting the tension of vehicle control linkage. The apparatus is supported by friction-reducing means to facilitate low-drag, repeated push-pull movement of its respective control linkage. Each actuator has a lead screw driven by rotational drive means such as a stepper motor, motor or servo. Rotation of the lead screws positions a carriage which in turn, adjusts the operative length of control linkage attached to the carriage.

FIG. 23C is an end view of apparatus similar to those shown in FIGS. 23A, 23B, 24A and 24B. In FIG. 23C guide rails are shown encompassing friction reducing means, e.g. wheels or bearings, to prevent the latter from becoming derailed.

The apparatus of FIGS. 23C, 24A and 24B are shown having rotational drive means redundancy. In FIG. 23C, the apparatus can optionally include a rotational transmission means such as a belt or chain for coupling the rotation of motor-driven pullies or sprockets. In FIGS. 24A and 24B redundant rotational drive means drive the same lead screw.

FIGS. 25A and 25B are top views of the physical control linkage adjustment means shown in FIGS. 23A and 23B respectively.

FIGS. 26A and 26B are side views of physical control linkage adjustment means similar to those depicted in FIGS. 23A and 23B respectively. The apparatus of FIGS. 26A and 26B are shown suspended from upper friction-reducing means, to facilitate low-drag, repeated push-pull movement of their respective control linkage. Each actuator has a lead screw driven by rotational drive means such as a stepper motor, motor or servo. Rotation of the lead screws positions a carriage which in turn, adjusts the operative length of control linkage attached to the carriage.

FIGS. 27A and 27B are partial cross-sectional top views of physical control linkage adjustment means that are equipped to be responsive to hydraulic or pneumatic pressurization to (1) disable manual input of attached control linkage, or (2) to re-enable manual control input of attached control linkage.

FIGS. 28A and 28B are side views of physical control linkage adjustment means mounted near the end of a manual control input arm, or member. The apparatus is equipped with rotational drive means such as stepper motors, motors or servos, and rotational transmission means for transferring the drive means rotation to a gear-driven sprocket to disable or re-enable manual control input to the physical control linkage attached thereto.

### DETAILED DESCRIPTION OF THE PREFERRED EMBODIMENTS

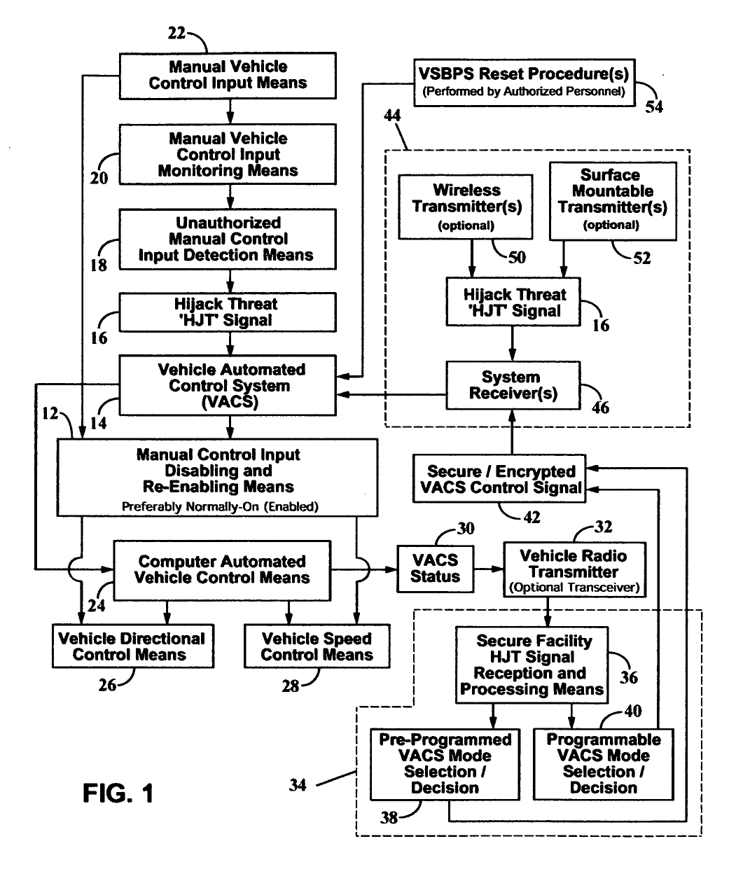

In FIG. 1, a flow diagram of a preferred embodiment of the present invention depicts the components comprising a vehicle suicide-bombing prevention system 10, hereafter referred to as ‘VSBPS.’ The VSBPS has a manual control input disabling and re-enabling means 12 which is equipped to receive and is responsive to one or more control signals communicated from a vehicle automated control system 14, the latter is hereafter referred to as ‘VACS’ 14. The VACS 14 is equipped to receive one or more security-related signals or hijack threat signals 16 hereafter referred to as ‘HJT signal’ 16. In a first embodiment of the present invention, HJT signal 16 is preferably transmitted from one or more onboard wireless transmitters 50 and/or one or more onboard surface mountable transmitters 52, to one or more system security-related signal receiver(s) 46, the latter having a communications link with VACS 14. Preferably, transmitted HJT signals are transmitted as secure and/or encrypted signals, and can include transmission and reception of a rolling code such as the type employed by Genie® garage-door opening and closing communications equipment, wherein four billion transmitted codes must occur before any transmitted/received code is repeated. The advantage of the employment of a rolling code in the VSBPS is that communications cannot be monitored (for example, a transmission frequency) and then replicated. Surface mountable transmitters 52 can be wireless or connected, sending secure and/or encrypted signal to their respective receiver(s) 46, and in the latter case send transmissions through one or more conduits, such as electrical conduit or optical conduit. Transmitters 50 and 52, and receiver(s) 46, can optionally be equipped to function as transceivers capable of sending and receiving communications signals. Elements 50, 52, 16 and 46, shown enclosed within dashed-line border 44, are related to the hijack disabling system described in the co-pending patents referenced above.

In a second embodiment of the present invention, the VACS 14 is equipped to receive and be responsive to, one or more HJT signal(s) 16 when an unauthorized type, degree, or exceeded, pre-determined threshold or limit of vehicle control input is encountered, or attempted, via one or more manual vehicle control input means 22. Unauthorized types of input can include, but are not limited to: vehicle control input that attempts to direct a vehicle significantly off-course, or at an object of strategic, symbolic or economic value, or at a building, structure, or combination(s) thereof, or at facilities or events having large numbers of people; or control input that directs, or diverts for too long, a vehicle from one or more acceptable: pre-determined or programmable courses, altitudes or destinations; or GPS-monitored location, or attitude and/or altitude; or any of a selection of, or variety of, acceptable or pre-authorized courses, alternative courses, destinations, coordinates, paths, vectors, slopes, attitudes, directions, approaches, lanes, rails, and the like. In this second embodiment, the VSBPS 10 includes (1) intelligent processor means, or one or more computers, for storing such types of information electronically, and (2) means for retrieving and comparing such information against storable and retrievable data which represents acceptable vehicle control input. The manual vehicle control input monitoring means 20 is equipped with any one or more in a variety of sensing means suitable for monitoring and conveying information pertaining to acceptable degrees of manual, human control input to a vehicle, and is also equipped separately, or in combination with the VACS 14, to detect when such input exceeds acceptable limits, having one or more unauthorized manual control input detection means 18 for transmitting one or more suitable HJT signal(s) 16 to the VACS when acceptable manual control input is encountered.

Preferably the vehicle suicide-bombing prevention system ‘VSBPS’ 10 is equipped with one or more HJT status reporting means to report VACS status 30 e.g., ‘ON’ of ‘OFF’ to a vehicle's operator(s) and/or authorized personnel. VSBPS-equipped vehicles can also have one or more vehicle radio transmitters 32, or optionally one or more transceivers, to convey any pertinent information regarding the identification and current condition or status of the vehicle, to one or more secure facility HJT reception and processing means 36. Such transmitters or transceivers can include, or have a communications link with, means for transmitting hijack information/codes, including but not limited to, transponder codes.

The secure facility(s) preferably has one or more personnel authorized to: (1) evaluate and process information pertaining to a vehicle hijack threat; (2) optionally make decisions regarding the destination of a vehicle; and (3) is equipped and authorized to immediately communicate pertinent information to all relevant agencies, and to grant that aircraft an emergency status and priority clearance. In response to a HJT signal 16, a hijack threatened aircraft flies a predetermined flight path (authorized before departure), or one or more among a selection of pre-determined flight paths. In one embodiment, the flight path(s) of aircraft is/are determined by computer automated vehicle control means ‘VACS’ 24 comprised of one or more computers or computer systems, equipped to operate a transportation vehicle in one or more automated modes. For example, with commercial aircraft, such computers and/or computer systems can include, but are not limited to, any one or more, or combination of, the following: flight control computer (FCC); flight management system (FMS); flight director (F/D); flight management computer system (FMCS); flight management computer (FMC); digital flight control system (DFCS), autopilot (A/P); autoflight system; automatic flight controls (AFC); inertial reference system (IRS); inertial reference unit (IRU); auto-throttle system (A/T) or computer; autoland system (A/L) or computer; thrust management computer (TMC); electronic engine control; flight level change system, digital air data computer, and so forth. The computer automated vehicle control means 24 can also be equipped with one or more intelligent processor(s), computer(s), or computer system(s) responsive to data and/or signal such as, but not limited to, any one or more of, or combination of the following: HJT signal; vertical control data; lateral control data; speed control data; latitude data; longitude data; altitude data; attitude data; encoded or decoded data; encrypted or decrypted data; pulsed signal; signal having a voltage and/or current signature; IRS data; inertial reference unit (IRU) data; control display unit (CDU) data, and/or built-in-test-equipment (BITE) data; data communicated in the ARINC 429 digital format; data sent to or from an ARINC I/O card; data sent through a digital information transfer system (DITS), data provided by a digital air data computer system (DADC), or data provided by digital analog adapters (DAA), sensor data, and so forth.

With aircraft, the VSBPS 10 provides all of the economic, time-saving and flight performance advantages and benefits of the automated cruise and autoland phases of flight. For example, upon receiving a HJT signal 16, the VSBPS is equipped to combine these two most commonly used and well-proven modes of automated flight, ensuring minimum cost flight profiles for climb, cruise and descent modes of automated flight. Thus, the aircraft is safely equipped to economically complete a flight without course or altitude deviation, in the most efficient manner and do so using existing well-established, flight automation systems already integrated into aircraft having fly-by-wire ‘FBW’, partial FBW and no FBW capabilities. Little R&D or cost of integration for other/new forms of flight-automating computer systems is required.

A VSBPS-equipped aircraft responding to a HJT signal 16 and having transmitted signal indicating its HJT state to one or more secure facility, which can include one or more air traffic control ‘ATC’ facilities, is given priority clearance to fly to, either its originally scheduled destination, or to alternative pre-authorized airport equipped with autoland capabilities. To the passengers, flight crew and authorized flight personnel aboard the aircraft experiencing an automated flight and landing implemented by the VSBPS, the aircraft continues to operate in a completely normal manner.

Aircraft, or other vehicles, having bi-directional communications with one or more secure facilities, can optionally receive secure and/or encrypted VACS control signal 42 with one or more system receiver(s) 46 having a communications link with a vehicle automated control system ‘VACS’ 14. When so-equipped, authorized personnel at the secure facility(s) can optionally select and transmit VACS control signal 42 which determines one or more automated transportation modes, vectors, courses, approaches, destinations or landings, and the like. A pre-programmed VACS mode selection/decision 38 transmitted in a control signal 42 and received by receiver(s) 46 and sent to the vehicle's VACS 14, determines which mode(s) among a selection of pre-programmed automated transportation modes will be implemented. Preferably, the secure facility HJT signal reception and processing means 36 is equipped to receive data from a vehicle pertaining to its available choices of pre-programmed transportation modes. In another embodiment, a programmable VACS mode selection/decision 40 can be transmitted in one or more control signals 42 and received by receiver(s) 46 and sent to the vehicle's VACS 14. VACS mode selection/decision 40 determines which programmable automated transportation modes will be implemented, including but not limited to, one or more automated transportation modes, vectors, courses, approaches, lanes, rails, destinations or landings, and the like. Preferably, the secure facility HJT signal reception and processing means 36 is equipped to receive confirmation data sent from a vehicle radio transmitter 32 which confirms which pre-programmed, or in-flight programmed, transportation mode(s) has/have been selected. Such modes include automated safe rapid descents and low altitude flights/courses following a depressurization of an aircraft.

Alternatively, the secure facility(s)' reception and processing means 36 can include the options of providing voice, or voice with video, transmissions, to optimally improve communications between any threatened aircraft, or other vehicle type, and the secure facility(s). The facility(s) can optionally be equipped with voice-stress analysis and/or voice-recognition equipment to monitor and assess the voices of flight personnel communications for above normal levels of stress (or other abnormalities), and for identification purposes, as they speak. Image-recording, processing and recognition systems and communications equipment for transmitting, receiving and analyzing image-recorded information pertaining to the identification of one or more vehicle personnel, can also be included, solely, or in combination with voice and/or other radio signal transmitting equipment. Thereafter, if any suspicious, unannounced or unexplained diversion, altitude or course change of that aircraft/vehicle occurs, any one or more of the facility(s) can instantly reinstate a previous, or transmit a new, automated transportation mode signal, which can include the previous, or a new, destination. When communications from one or more identified authorized personnel aboard an aircraft, or other vehicle type, is sent to the facility(s) and is determined to be free of abnormal levels of stress, (after a HJT signal has been sent from the vehicle), a facility can optionally transmit a secure signal 42 to the aircraft/vehicle which resets the VSBPS 10 to a non-automated, normal operational mode. When voice communications are provided between the aircraft, or other vehicle type and the facility(s), the VSPBPS can optionally limit the communications to a predetermined amount of time following a HJT signal 16 (e.g. 5 minutes), to minimize any possibility of a hijacker using that time to try to negotiate a desired outcome.

Thus, in the embodiments of the VSBPS having communications with one or more secure facilities, the latter has the options of (1) determining one or more transportation modes, paths, airports, courses, vectors, or destinations, and the like, or (2) can simply allow a vehicle to default to one or more pre-programmed automated transportation modes to safely conclude its journey to a destination.

In the event that an aircraft, or other vehicle type, is purported to be carrying a weapon of mass destruction such as a chemical, biological or nuclear threat, or such threat has in fact been substantiated, the aircraft/vehicle, depending on the threat potential, can be directed to land in an unpopulated area, such as a formerly operating military airbase equipped with an active autoland system.

In all instances, where an aircraft lands, or a vehicle is directed to stop, with any degree of viable threat still aboard the aircraft/vehicle, that vehicle will remain disabled by the VSBPS until all threats have been eliminated, and preferably authorized ground based security personnel board the vehicle to reset the VSBPS for normal operation. In extreme cases, such as those where the taking of one or more hostages aboard an aircraft might occur, or where one or more terrorists might refuse to surrender, aircraft can be equipped with, or provide attachment means to, a supply of incapacitating gas(es), which can be activated by a secure/encrypted signal when the gas supply is onboard, or can be activated from an externally attached gas supply when coupled to a vehicle (any gas used for such purposes would have a predictable and known temporary effect).

The VSBPS is equipped to receive and be responsive to one or more VSBPS reset procedure 54 for example, to reset the system following a false deployment, or following a subdued threat, or after a vehicle has come to a stop and authorized personnel perform an authorized reset procedure. In the event of a false deployment, the VSBPS provides a variety of procedures for resetting the operative flight automation computer(s) to a previous, normal flight mode with, or without, the intercession of secure control signal being sent from a ground based facility. For example, if a well-intentioned flight attendant or passenger sends a HJT signal by mistake or, following the sending of a HJT signal a flight marshal easily subdues a ‘mild threat’ (e.g. an ill-behaved passenger) while a plane is still in flight, it would be preferable to reset the VSBPS immediately and for the flight crew to resume full and normal control of the aircraft. Following a substantiated verification that a threat aboard an aircraft has been sent by mistake, or is subsequently subdued, to the satisfaction of the pilot in command, one of several VSBPS reset procedures can be implemented.

In an onboard transmitter-signal reset procedure, following an audible (or other) cue initiated by the pilot, or other authorized personnel, preferably a plurality, or a majority, or all, personnel having a transmitter aboard an aircraft, send a subsequent HJT signal from their respective transmitters within a predetermined limited time period, for example, within ten seconds of one another. When the system receiver(s) 46 receives the near-simultaneous control signal while in an HJT automated flight mode, the system immediately reverts to its previous non-automated, normal flight mode. Thereafter, the VSBPS remains active to respond to any other HJT signal that may be sent later by flight personnel from one or more transmitters. Following the reset procedure, the aircraft is preferably monitored from the ground, or by onboard monitoring means 20, for any irregularities in its flight plan, and facility based personnel can periodically communicate with the pilots (or other/specified personnel) to assess the plane's status. At the first hint of any suspicious action or communication e.g., an unexpected, atypical or unexplained aircraft direction or altitude change, the facility has the option to immediately place the plane in a second automated flight mode which no one aboard the aircraft can reset. Optionally each transmitter and receiver has an indicator to clearly indicate the current “ON” or “OFF” status of the VSBPS and each transmitter or transceiver is identifiable with a given authorized user.

In an optional facility transmitted-signal reset procedure, a variation of the procedure just described is achieved by the facility transmitting a secure reset signal to the aircraft system receiver(s) 46 after the facility receives verification that a majority, or all, transmitter-equipped personnel have sent a first, or a second, HJT reset signal from their respective transmitters.

In an optional pilot reset procedure, either or both pilots has access to a nearby reset button which he or she presses to reset the VSBPS. Following the resetting of the VSBPS, the plane is closely monitored and is again responsive to one or more HJT signals to be placed back into one or more secure automated transportation modes as described above. Any subsequent false deployment could additionally require a coordinated resetting of the VSBPS by one of the pilots and one or more authorized personnel in communication with the pilot, wherein the latter must (1) send a plurality of the coordinated signals as described in the first reset procedure, and/or (2) send one or more secure reset signals from a secure facility.

In addition to the procedures described above, the VSBPS can optionally include manual vehicle control input monitoring means 20 for monitoring control input during and after HJT signals are sent. If certain unsafe, atypical, or gross change to the heading, altitude or attitude of the aircraft is attempted, unauthorized manual control input detection means 18 immediately conveys a HJT signal 16 VACS 14 which places the aircraft (or other vehicle) back to a HJT automated mode. Preferably, when a subsequent HJT signal follows a reset after a first deployment no one aboard the vehicle can then reset the system and the aircraft or other vehicle concludes its journey using one or more safe automated transportation modes. The monitoring means 20 and unauthorized manual control input detection means 18 can also include monitoring any change to the flight controls in excess of a predetermined period of time typical of that aircraft's (or other vehicle's) then-current transportation mode such as a cruise, approach, or landing mode of operation, optionally allowing an acceptable range of manual control input relative to the then-current flight, or operational, phase. If, after a HJT signal is received, the acceptable-range of input to one or more controls exceeds a pre-determined normal input range (optionally including time-limited manual control inputs for emergency maneuvers) then the VSBPS's automated control system takes over (A) while manual input exceeds an allowable range, or (B) until the journey is completed. Terrorists therefore, have no incentive to coerce or harm any of the flight crew, flight personnel, or passengers, before or after a HJT automated mode, because any atypical, unexplained and/or persistent change to the control input of the aircraft places the aircraft in an automated mode. Thus, attempts at suicide-bombings conclude with the terrorists, in effect hijacking themselves, because the aircraft (or other vehicle) only goes where it is allowed and in all cases, preferably remains inoperable once it has come to a stop and all parties are removed from the vehicle.

Other ‘reset’ procedures are also possible. For example, the VSBPS can alternatively be reset by employing one or more of the following types of technologies for verifying the identification and communications of one or more authorized personnel aboard a vehicle and evaluating whether or not a reset should be allowed: voice-stress analysis; voice-recognition; image-recognition or biometric-recognition such as face and/or eye/iris, fingerprints, and the like. In each case, the resetting of an aircraft's VSBPS is experienced as a normal flight by the passengers of the aircraft.

Thus, the prospect of turning a commercial jet into a ‘guided missile’ to achieve the destructive aims of terrorists is eliminated, and a failsafe system for preventing the suicide-bombing of commercial aircraft is achieved.

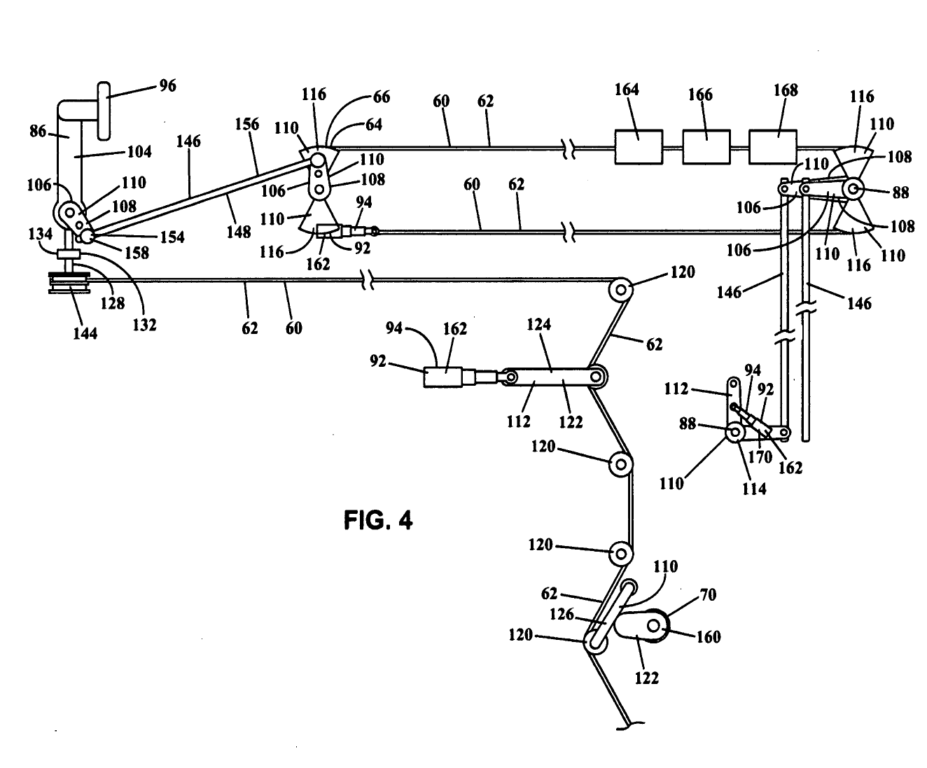

The VACS 14 of VSBPS 10 has a communications link with one or more manual control input disabling and re-enabling means 12 and with one or more computer automated vehicle control means 24 and upon receiving one or more type of hijack threat signal or unauthorized control input signal is equipped to disable or render ineffectual manual control input of the vehicle and operate the vehicle in one or more automated transportation modes. Preferably the automated vehicle control means is also equipped with, and has a communications link with, vehicle directional control means 26 and vehicle speed control means 28. FIGS. 4 through 28 illustrate a variety of examples of physical control linkage components which can be adjusted by manual control input disabling and re-enabling means 12.

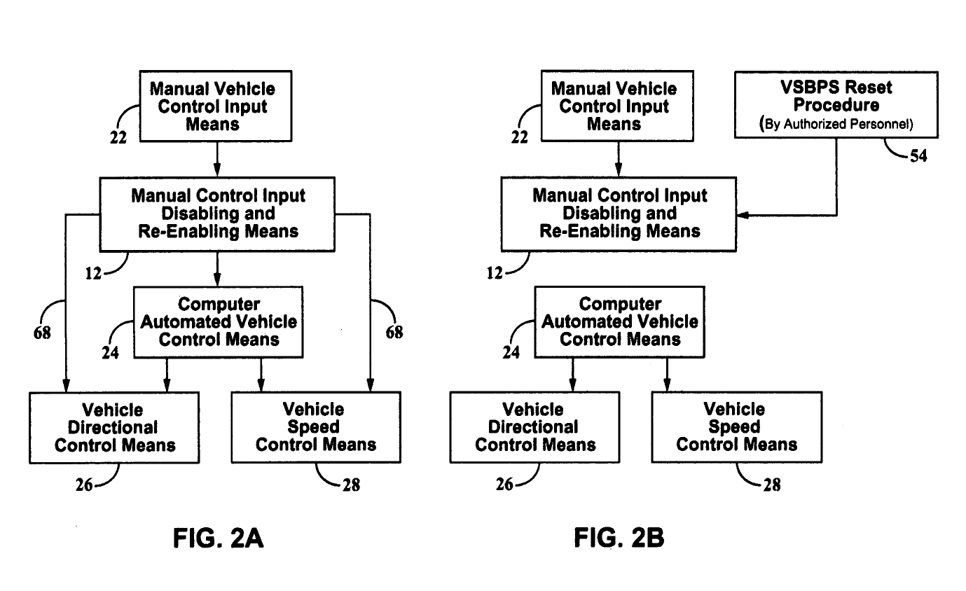

In FIGS. 2A and 2B, a manual control input disabling and re-enabling means 12 is shown in a series of VSBPS components positioned and operative after manual control input is initiated and before computer automated vehicle control means 24 controls a vehicle. In FIG. 2A, disabling and re-enabling means 12 is in a non-disabled (or enabled) state and the combination of manual vehicle control input means 22 and disabling and re-enabling means 12 convey manual vehicle control input 68 to the manual control inputs of a vehicle. For example, with vehicles having direction control means 26 and vehicle speed control means 28, the manual control input is conveyed to those control means in a typical manner. For vehicles such as trains or monorails and the like, not having vehicle directional control means 26 manually inputted by one aboard the vehicle, the combination of manual vehicle control input means 22 and disabling and re-enabling means 12 convey manual vehicle control input 68 to vehicle speed control means 28.

Vehicle directional control means 26 and vehicle speed control means 28 include one or more vehicle automating computer(s) or computer system(s) for controlling any of the automated transportation modes or parameters previously described.

FIG. 2B, depicts the manual vehicle control input 68 in a disabled state wherein computer automated vehicle control means 24 provides automated control of vehicle speed control means 28 and/or vehicle direction control means 26. FIG. 2B also depicts a system reset procedure for re-enabling manual control of the vehicle by resetting the VSBPS to a state depicted in FIG. 2A.

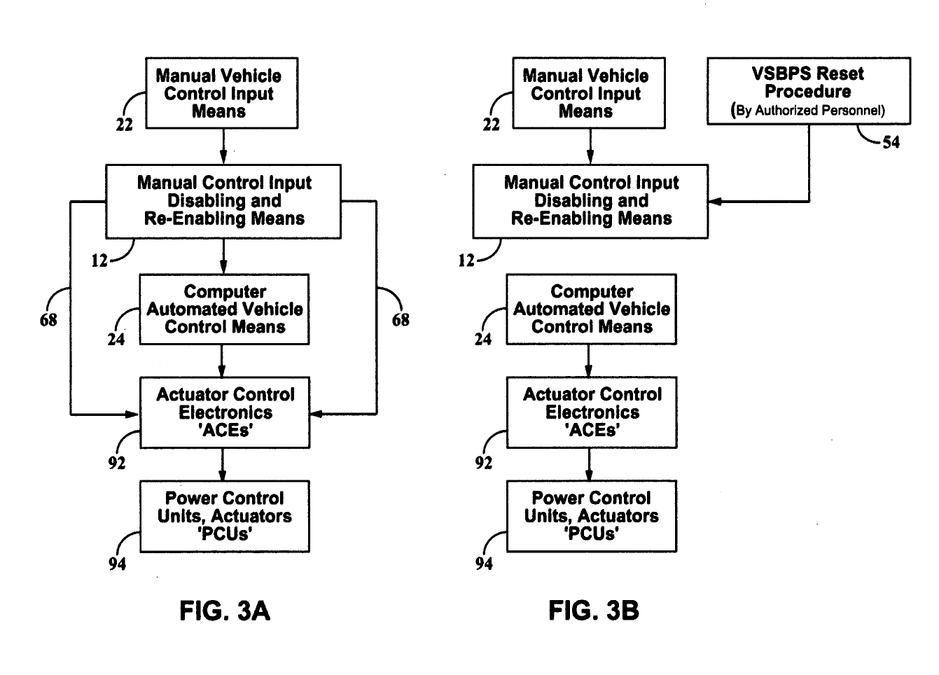

In FIGS. 3A and 3B, a manual control input disabling and re-enabling means 12 is shown in a series of VSBPS components positioned after manual control input is initiated and before computer automated vehicle control means 24 controls a vehicle either partially, or fully, equipped with fly-by-wire ‘FBW’ capability. In FBW systems, manual control input is monitored, sensed and measured preferably as an analog signal and converted to a digital signal. In FIG. 3A disabling and re-enabling means 12 are depicted in a non-disabled or enabled state. In an enabled state, the combination of manual vehicle control input means 22 and disabling and re-enabling means 12 convey vehicle control input 68 digital data to the components of a vehicle capable of controlling the speed-related and/or direction-related functions of the vehicle in one or more automated modes. For example, in the case of aircraft having partial FBW, or full FBW capabilities, the aircraft typically has actuator control electronics 92 ‘ACEs’ and power control units 94 ‘PCUs’ (shown in FIGS. 3A and 3B) which are responsive to manual vehicle control input signals in FIG. 3A and are not responsive to manual vehicle control input signals in FIG. 3B.

FIG. 3B depicts a relationship between components of the VSBPS in a disabled state, following the system receiving one or more HJT signals, wherein manual control input disabling and re-enabling means 12 disables manual vehicle control input signal, whether analog, or digital, from being sent to the computer automated vehicle control means 24. In FIG. 3B, the computer automated vehicle control means 24 is depicted operating in an automated mode sending control signal to ACE's 92 and power control units 94 ‘PCUs’ controlling the aircraft's automated transportation mode(s). FIG. 3B also depicts a system reset procedure 54 for re-enabling manual control of the vehicle which, can be implemented by any one or more of the reset procedures described in the system depicted in FIG. 1.

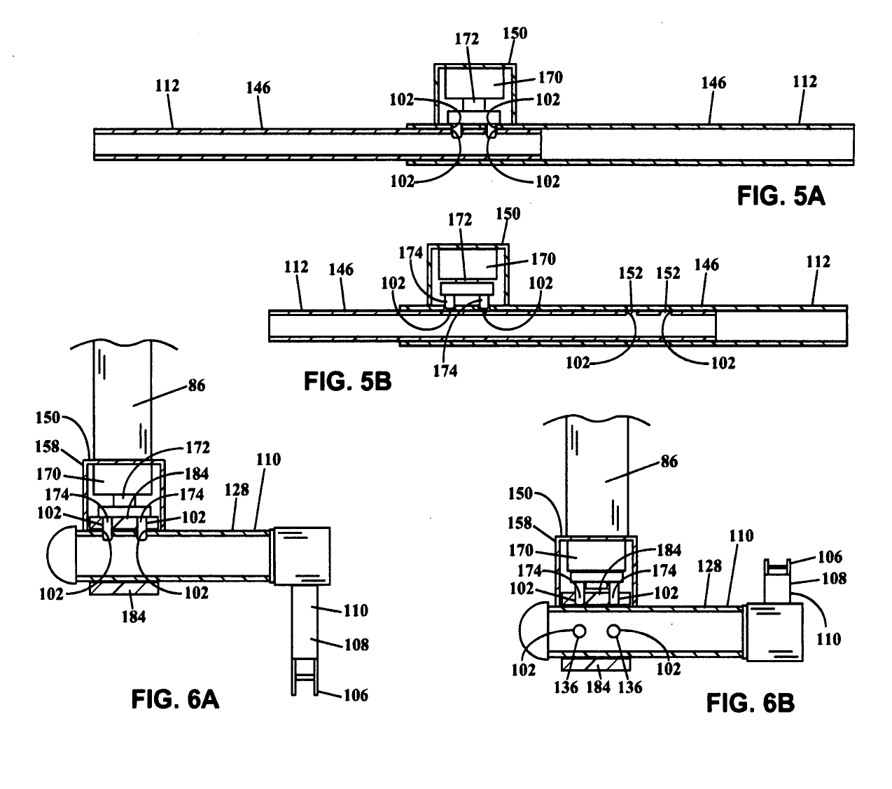

FIG. 4 diagrammatically depicts the side view of a variety of components commonly used in the physical control linkage of vehicles such as aircraft, ships and trains and identifies several locations within the linkage, after manual control is initiated and before computer automated vehicle control means controls a vehicle, where one or more manual input control means can be selectively disabled, or re-enabled, by one or more manual control input disabling and re-enabling means 12 without defeating the safe automated control of the vehicle. The descriptions below, pertaining to the illustrations of FIGS. 5 through 28 provide in-depth details of such components and of the various types of manual control input disabling and re-enabling means 12 that are employable by the VSBPS. In FIG. 4, a control yoke 96 is shown at the upper end of a manual control input member 86 or control column 104. A control input arm 106, lever 108, or rotationally positioned member 110 is rotatably mounted at a lower end of control column 104 and at the upper end of a control input arm 106 of quadrant 116. At the end of input arms 108 a lock release means 154, or stroke adjustment means 158, is equipped to receive hijack threat ‘HJT’ control or reset signal and is pivotably mounted having an aperture through which a push-pull member 146 such as a tube, or actuator rod 148, slideably fits when the aperture of means 154 or means 158 is set in a manual control input disabled mode. When means 154 or means 158 is in an enabled, or re-enabled state, the rod or tube is unable to slide within the aperture and manual control input to the input arm 106 or lever 108 is transferred normally to the push-pull member 146 (see also FIGS. 5A and 5B). Similarly, a slotted rod 156, or tube, (slot not shown) can alternatively interact with means 154, or means 158 alternatively equipped with a clamping pin which is (1) slideable within the slot when means are set to a disabled state, and (2) not slideable in the slot when means 154 or 158 are set to an enabled, or re-enabled state.

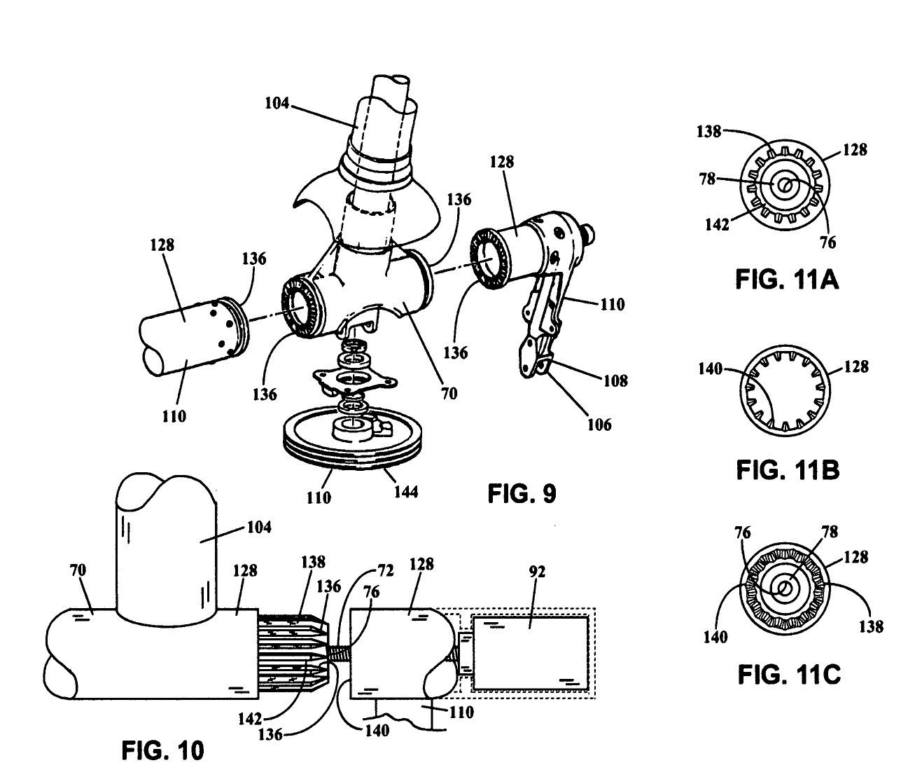

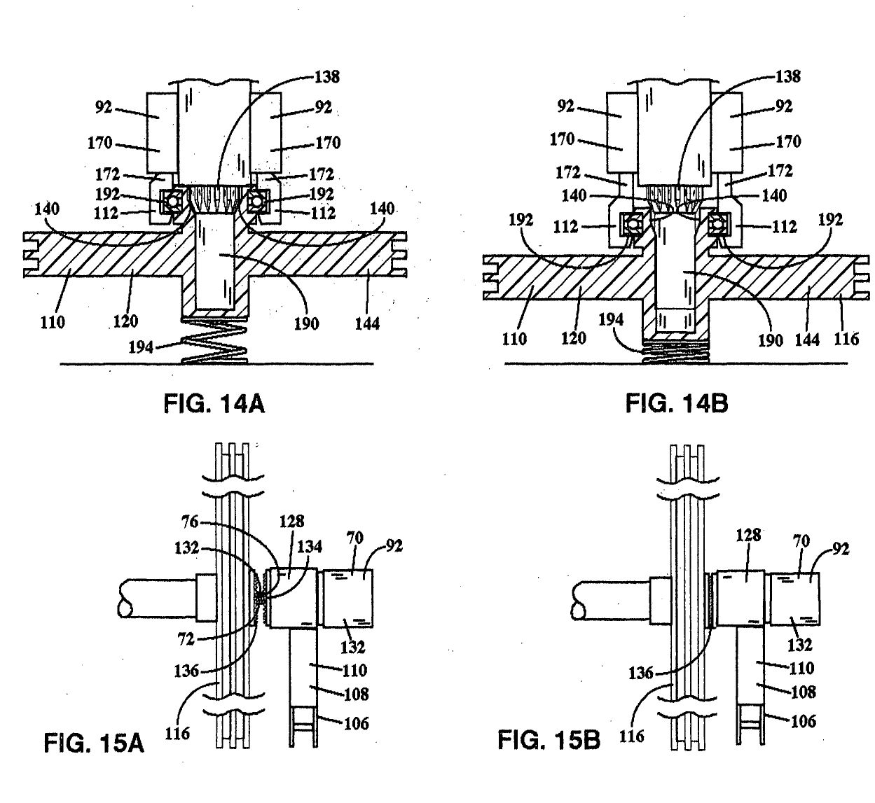

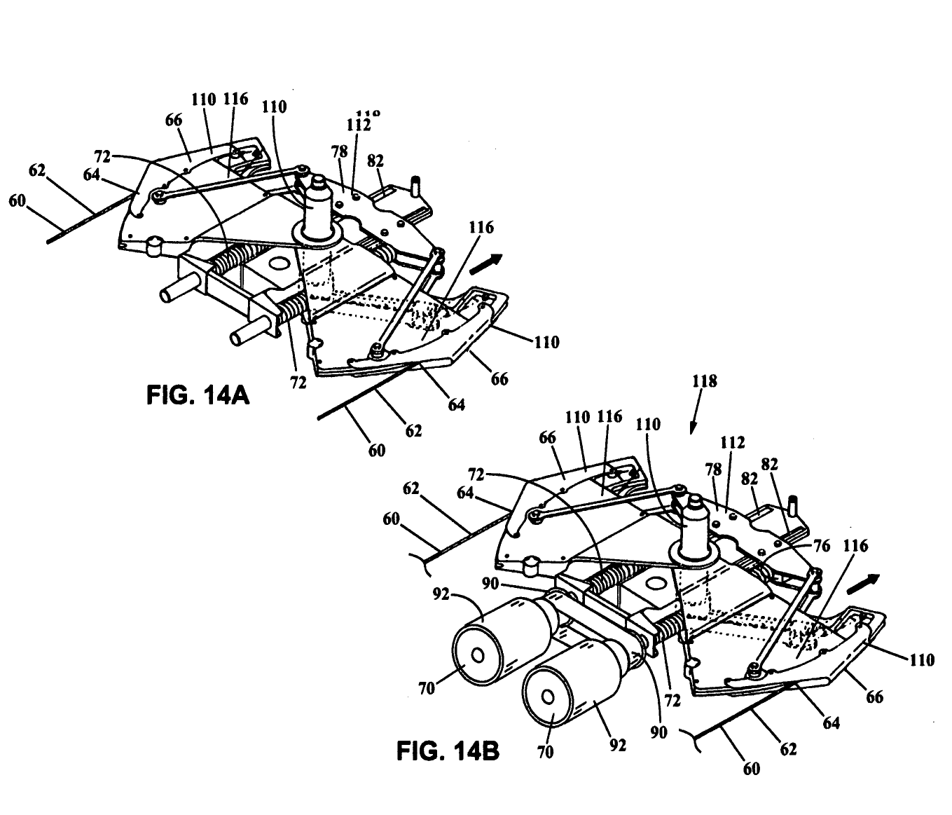

At the lower end of control column 104 a shaft extends downward to a rotational drum 144 such as the type commonly employed on commercial aircraft for transferring manual aileron control cable input to aileron boost pump stages and/or aileron actuators. Above the drum is a torque tube release means 134 having one or more actuators which are equipped to be responsive to one or more HJT signal to disable or enable the manual rotation input from the shaft above the release means 134 to the shaft connected with the drum 144 below (see also FIGS. 9 and 14A and 14B).

At an end of quadrant 116, bell crank 114 and pulley positioning means 122, one or more linear actuators such as electrical hydraulic, solenoid or pneumatic linear actuator(s) 92, 94, 170 or 162 respectively, are pivotably mounted, or otherwise attached, which are equipped to be responsive to one or more security-related control signals to disable or enable the manual control input to the physical control linkage attached thereto (see FIGS. 16A through 28B). It is noted that a broad range of reliable, new and decades-proven actuation technologies are available and employable in the physical linkage components of a VSBPS.

In each of these variants, the physical control linkage attached to the actuator(s) (1) provides typical manual control input via the control linkage when the actuators retain the linkage in an enabled state, and (2) disables the manual control input, solely, or in combination with one or more actuators positioned elsewhere, when the actuators position the linkage in a disabled state. It is noted that wherever manual control input disabling and re-enabling means 12 of the VSBPS are operative, whether (1) positioned to physically disable and/or enable manual control input to the control linkage of a vehicle; or (2) having a communications link or other electrical, or electronic, means for disabling or enabling analog or digital control input signal; that such disabling and/or enabling takes effect at a point after manual control input is initiated and before the vehicle's computer automated vehicle control means 24 is operative during one or more automated transportation modes. Thus, the disabling of one or more control linkage components, or of control input signal, before one or more vehicle computer automation stage(s) 168 is provided by the VSBPS. For example, if there is a hydraulic boost stage 166 and/or a feel computer/damper means 164 located in series prior to automation stage 168, and each component is equipped with the means to receive, and is responsive to, one or more HJT signal or reset signal, either, or both, the boost stage 168 and feel computer/damper means 164, can also be independently adjusted to assist in a disabling or enabling of a given flight control. Thus, one or more actuators or pumps responsive to HJT and reset signals, can be selectively controlled to reduce the hydraulic pressure of the boost stage 166 (or other hydraulic stage) to an ineffectual degree. Similarly, one or more feel computer apparatus, equipped with a range of dampening sufficient to prevent manual control input, can optionally be controlled to a degree where movement of a manual control input means is prevented, and in either, or both cases, the vehicle computer automation stage 168 continues to independently operate the vehicle in one or more automated transportation modes.

One or more control input arms 106 and/or rotationally positioned members 110 can alternatively be disabled and enabled at an interface where the arms or members are attached to a respective rotational torque tube or rod. In such cases, the interface between an arm 106 or member 110 and the tube or rod, can have an interlocking male and respective female relationship, such that one or more actuators, or linear actuators, responsive to one or more HJT signals or reset signals can (1) cause the actuator(s) to separate the interlocking elements to disable a simultaneous rotation of the tube or rod and its respective arm or member, or (2) cause the actuator(s) to position the interlocking elements together to enable a simultaneous rotation of the tube or rod and its respective arm or member (see also FIGS. 6A and 15B).

In the lower part of FIG. 4, a cam adjustment means 160 is positionable by a rotational drive means 70 and serves as a pulley positioning means 122 which adjusts a tensioner 126 or positionable idler, which is pivotably mounted at one end and has a guide pulley 120 rotatably mounted at an opposite end. The cam adjustment means 160 is shown in an enabled, or normally-on, position which provides sufficient tension to a control cable 62 to allow typical manual control input. Similarly, a pulley positioning means 122, shown above the cam adjustment means 160, is shown in an enabled, or normally-on, position which provides sufficient tension to a control cable 62 to allow typical manual control input. Cam adjustment means 160 and pulley positioning means 122 are positioned by one or more actuators that are equipped to be responsive to one or more HJT signals, or reset signals. The actuator(s) provide an adjustment range sufficient solely, or in combination with one or more other disabling and enabling means, to control the effective length of a control cable to disable or enable control cable manual control input. It is noted that any one or more of pulley 120's can additionally be equipped with a pulley cable guide which is positioned near and beyond the outer diameter of one or both sides of a pulley in a manner ensuring the proper alignment of a cable in its respective pulley when the control cable input is either disabled or enabled.

Any one or more in a variety of commercially available actuators are, and any combination thereof is, employable in the VSBPS, including, but not limited to, actuators and linear actuators of the following types, whether used solely or in a redundant or tandem manner: electrical, electronic, electro-mechanical, solenoid, two-position, multi-position, hydraulic, pneumatic, motor-driven, stepper motor-driven, servo-driven, diaphragm-driven, and the like. Two-position or multi-position solenoids can be employed in the VSBPS, including solenoids that maintain one or more positionings without a supply of current. Preferably, actuators are employed redundantly in the VSBPS and are of a type that are in a normally-on state providing manual vehicle control input during normal operation of a vehicle without requiring adjustments, or current, or gas or liquid pressure changes, to the actuator(s) for typical vehicle operation. VSBPS actuators can optionally be equipped to receive and be responsive to secure and/or encrypted control signal, and preferably have circuitry which only accepts voltage and/or current of a particular type or having a wave signature identifiable by the system, so that the actuator(s) cannot be ‘hot-wired’ when connected to a transportable generator or battery supply.

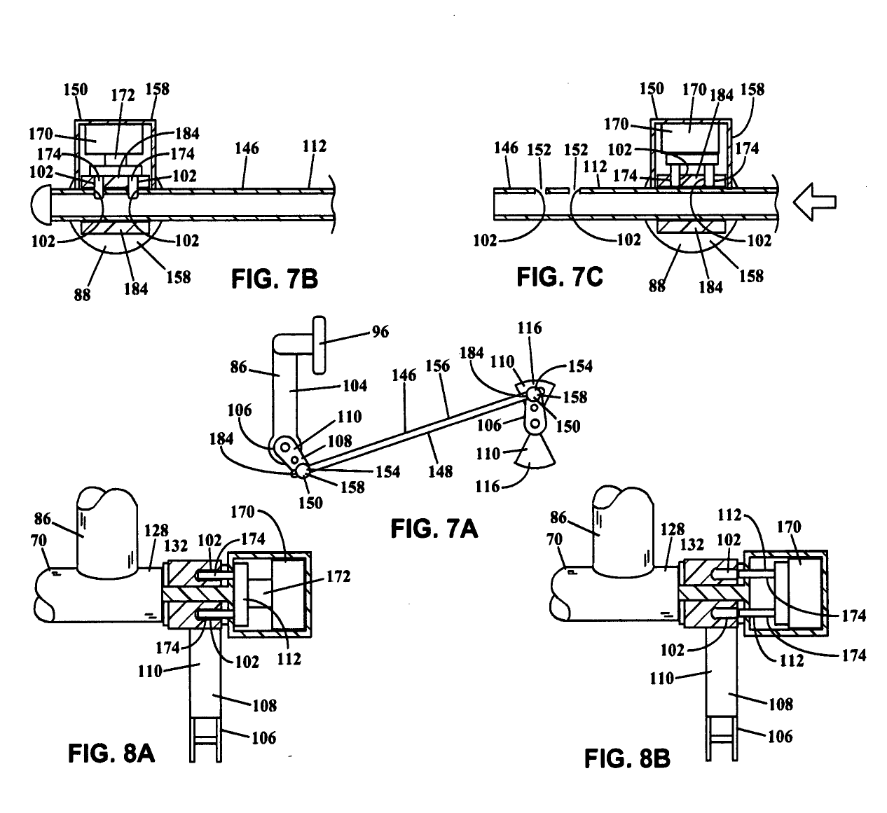

FIGS. 5A and 5B show cross-sectional side views of control means for selectively disabling and re-enabling vehicle control linkage, comprising a push-pull member 146 such as a push-pull tube or rod slideably positioned within another tube, wherein an actuator member interacts with the inner tube or rod to enable or disable the sliding of the tube or rod within the outer tube. For example, the apparatus of FIGS. 5A and 5B could be positioned midway in the span of a push-pull member 146, or other type of linearly positioned member 112, to enable or disable the manual control input of that member. Alternatively, as depicted in FIGS. 7B and 7C, the outer tube of the apparatus can be shortened to approximately the width of push-pull locking means 150 operating as a sleeve 184, and the combination of locking means 150 and the sleeve 184 can comprise a stroke adjustment means 158 which can be pivotably attached adjacent to an end of a control input arm 106, lever 108, bell crank 114, quadrant 116, and the like. In each case, one or more actuators, such as solenoid(s) 170, position one or more locking pins 174 (or peg, or key) attached adjacent to the end of solenoid armature(s) 172 into, and out of, one or more lock pin apertures 102. The solenoid(s) can be of a type that is two positioned, or multi-positioned and which does not require current to maintain one or more positions. Alternatively, one or more other actuators, or linear actuators, can be employed for moving pin(s) 174 into and out of respective aperture(s) including, but not limited to: motor-driven lead screws (including employing motor-driven screws as lock pins), hydraulic actuators, pneumatic actuators, other electrical or electronic actuators, and the like. It is also noted that any one or more in a variety of reliable rod or tube clamping, engaging or locking means are commercially available and can be controlled by one or more different commercially available actuators and that such clamping and/or locking means are alternatively employable in the embodiments of the invention depicted in FIGS. 5A through 15B. These same embodiments can employ one or more self-centering or alignment means such as a spring mechanism, or separate linear or rotational actuating means, of a type commonly employed to linearly align, or rotationally align, a first member with another member. The spring mechanism type preferably has insufficient spring strength to transfer manual vehicle control input from one member to another, but has sufficient spring strength to return a positionable member to, or near to, an aligned and/or enabled position. The left pointing arrow seen in FIG. 7C indicates the direction of movement of a disabled push-pull member 146 after sliding in sleeve 184.

FIGS. 6A and 6B show partial cross-sectional side views of control means for selectively disabling and re-enabling vehicle control linkage comprising a torque tube 128 or rod rotatably positioned within a sleeve 184 with the tube or rod having a control input arm 106 or lever 108 attached to an end thereof, wherein an actuator means interacts with the torque tube or rod to enable or disable the rotation of the tube or rod within the sleeve. The combination of the control input arm 106 and the torque tube 128 are also referred to as rotationally positioned member 110. The torque tube 128 and sleeve 184 have one or more apertures 102 through which a respective lock pin 174 is positionable into and out of, an enabling or disabling mode (as described in the apparatus of FIGS. 5A and 5B) by one or more actuators, such as solenoid(s) 170. The locking means 150 houses the solenoid(s) 170, armature(s) 172 and lock pin(s) 174 and is attached adjacent to the end of manual control input member 86, such that (1) control input from member 86 is transferred to physical control linkage attached to control input arm 106 when the lock pin(s) 174 are engaged within lock pin aperture(s) 102, and (2) control input from member 86 is not transferred to control input arm 106, or rotationally positioned member 110, when the lock pin(s) 174 are not engaged within lock pin aperture(s) 102.

FIG. 7A depicts the side view of vehicle control linkage components including a push-pull member 146 such as a tube or rod, or push-pull tube or rod, operative within one or more push-pull member locking means 150. The combination of locking means 150 and the sleeve 184 can comprise a stroke adjustment means 158 which can be pivotably attached adjacent to an end of a control input arm 106, lever 108, bell crank 114, quadrant 116, and the like. FIG. 7A also depicts side views of control arms each of which can be disabled, or re-enabled, by alternative control means such as those illustrated in FIGS. 8-13.

FIGS. 8A and 8B show partial cross-sectional side views of control means for selectively disabling and re-enabling vehicle control linkage, comprising a torque tube 128 or rod which is rotatably positionable by a manual control input member 86 such as a control column. A torque tube locking means 132 is shown in cross-section having one or more lock pin apertures 102 and is rotatably mounted on a common shaft 196 shared by locking means 150 and torque tube 128. Means 150 houses one or more linear actuators such as solenoid(s) 170 which has an actuator arm, or solenoid armature 172 which is connected to and positions one or more locking pins 174 into, and out of, an equal number of respective lock pin apertures 102. When the lock pin(s) is positioned within a respective pin aperture by one or more actuators, a control input arm 106, or other lever 108, is able to transfer the rotation from rotational drive means 70 to vehicle physical control linkage, such as a control cable, attached to arm 106 or lever 108. Conversely, when the lock pin(s) is positioned outside a respective pin aperture by one or more actuators, a control input arm 106, or other lever 108, is unable to transfer the rotation from rotational drive means 70 to vehicle physical control linkage, such as a control cable, attached to arm 106 or lever 108. It is noted that alternatively, a control input arm 106 could instead be mounted to a lower wall of the locking means 150 and the locking means housing could be rotatably mounted on the shaft 196, in which case, the locking pins could be moved into and out of respective apertures formed in the end of tube 128 by a similar type of actuator arrangement. It is also noted that any in a variety of interlocking surfaces or contours can alternatively be employed and be positioned by one or more actuators for the purposes of disengaging and engaging such components to disable or re-enable respectively the manual control input to such control linkage.

FIG. 9 is an exploded three-dimensional illustration of adjoining torque tube 128 parts commonly fastened at the lower end of a control column 104 employed on commercial aircraft such as Boeing® 747's. The tube parts are made with interlocking ends that serve as torque tube interlocking means 136, such that when the parts are securely fastened together, forward and aft movement of the control column 104, causes the base of the column to function as a rotational drive means 70 which transfers rotational movements to rotationally positioned members 110, including the control input arm 106 attached at the end of a torque tube, and control linkage (not shown) attached to arm 106, or to a lever 108, such that arm 106 or lever 108 move in response to the movement of the column. Below the control column, an aileron rotational drum 144, or pulley, is shown, which, optionally can have an interlocking upper surface that is made to interfit with a corresponding interlocking receiving surface adjacent to an end of the control column, such that when the parts are fastened together, aileron control yoke input causes the drum attached at the end of the control column, and control linkage attached thereto, to move in response to the input of the yoke.

In FIGS. 10-16B, several apparatus are depicted wherein a torque tube member, control arm, lever, quadrant, quadrant sector, rotational drum or pulley, and the like, can be enabled for the transferring of manual vehicle control input, when one or more actuators retains or positions an interlocking contour surface, or male spline, thereof within a respective interlocking contour surface or female spline. Conversely, the same apparatus can be disabled when one or more actuators disengage, release or position an interlocking contour surface, or male spline, away from it respective mate.

For example, in FIG. 10, a rotatably positioned member 110, such as a control arm 106 or lever 108 seen in FIG. 9, is attached to a lower side of a torque tube 128 and the tube has an interlocking ending such as a female spline 140 formed around an inner perimeter. An electrical linear actuator 92 is shown within dashed-lines representing a surrounding housing and an extended portion of the tube 128. Actuator 92 provides rotational control of a lead screw 72 which is inserted into a follower 76 of a carriage 78 (see also FIGS. 11A and 11C) located at the center of a splined shaft 142 having male spline 138 contour. The splined shaft adjoins the end of a torque tube 128 which serves as a manual rotational drive means 70 attached to the lower end of a control column 104. Alternatively, for redundancy purposes, two electrical linear actuators equipped with gears can be employed to redundantly drive a single lead screw.

VSNPS actuator(s) are equipped to be responsive to one or more HJT signals, or reset signals. In FIG. 10 a counter-clockwise rotation of the lead screw 72 causes a de-coupling of the male and female splines, disabling manual control input of the control column from being transferred to rotationally positioned member 110. Conversely, clockwise rotation of the lead screw 72 causes a coupling of the male and female splines which enables the manual control input of the control column to be transferred to rotationally positioned member 110. It is noted that the interlocking contours seen in FIGS. 9, 12A through 13B and 15A and 15B have a relatively low profile and that minimal linear actuation is required to engage and disengage the contours. Therefore it is quite feasible, with the actuator positioning means described in the present invention, to position existing (or minimally modified) control linkage parts only a fraction of an inch to disable, and re-enable, the rudders, elevators and ailerons (as well as other directional and speed controls) of commercial aircraft, military aircraft, ships or trains.

FIGS. 11A, 11B and 11C illustrate three end views of the interlocking male and female members depicted in FIG. 10. FIG. 11A is an end view of the male interlocking member which slideably fits within the female interlocking contour of a torque tube or rod depicted in the end view of 11B. FIG. 11A shows the spline shaft 142 and the male spline 138 contour which slideably fits within the female spline 140 interlocking contour of a torque tube 128 or rod depicted in FIG. 11B. The male interlocking member can optionally be equipped with a threaded element or follower 76 and function as a moveable carriage 78. FIG. 11C shows the interfacing of the male and female interlocking contours (FIG. 11A and FIG. 11B respectively).

Additionally, the torque tube 128 at the bottom of control column 104 can be equipped with one or more alignment means (not shown) as previously described, to provide proper registration of a disabled member as the interlocking contours are being positioned together.

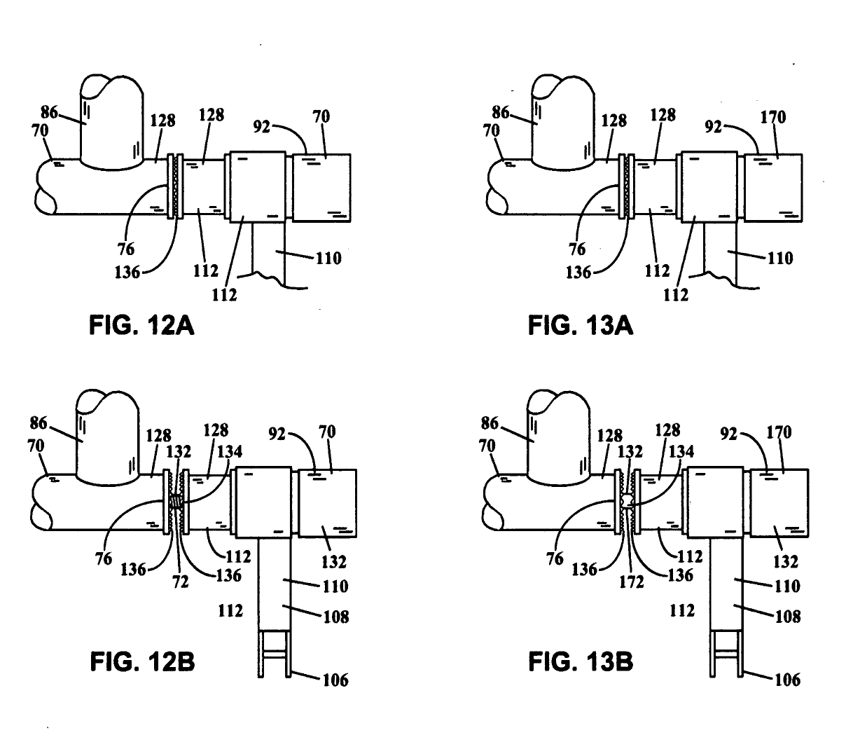

FIGS. 12A, 12B, 13A and 13B are side views of a torque tube 128 such as the type found at the end of a control column 86 of a commercial aircraft, wherein an end of the tube has a torque tube interlocking means 136 comprised of a relatively low-profile contour, such as teeth, which interfits with a corresponding female interlocking surface formed adjacent to an end of another torque tube 128 having a control input arm member 106 attached thereto. In a manner similar to one of those described previously, the combination of the control input arm 106 and female interlocking surface is positionable by one or more linear actuating means to, (1) interfit and lock with, or (2) be separated and unlocked from, the male interlocking surface. Thus, the apparatus shown in FIGS. 12A through 13B are quite similar to the structure and manual control input enabling and disabling operation of the apparatus described in reference to FIG. 10, with the exception that FIGS. 12A through 12B have low-profile torque tube interlocking means 136 (i.e. low surface contours), and the actuation means of FIGS. 13A and 13B are supported by, and interact with, a non-threaded shaft which serves as (1) an extended solenoid armature 172 and/or (2) as a torque tube locking means 132 in combination with its respective encased actuator(s).

FIGS. 14A and 14B are side views showing the lower end of a control column having a male spline 138 and control column shaft 190 which is co-axially positionable by one or more linear actuators such as a solenoid 170 into and out of a central aperture and female spline 140 of a rotational drum 144, or pulley 120. The rotational drum 144, or pulley 120, and optional thrust race bearing 192 are shown in a cross-section. The control column can have a single or redundant linear actuators, such as two-position solenoids 170 mounted adjacent to sides thereof, which control the co-axial uncoupling and coupling of the male and female spline by providing a range of adjustment suitable for disabling and re-enabling normal manual control input to the drum 144, or pulley 120, from the control column. Preferably, solenoid armatures 172 are positioned to clasp a friction-reducing means for example, a thrust race bearing 192, and optionally, another friction-reducing thrust race bearing is co-axially positioned either above or below spring 194 (spring bearing not shown). The spring serves as a biasing means to urge the drum 144 or pulley 120 in an upward normally-on, or enabled mode. In FIG. 14A, armatures 172 of solenoids 92 are retracted which positions the race bearing and respective drum or pulley in an upward position such that the male spline 138 and female spline 140 are coupled and rotation of control column shaft 192 and its respective male spline 138 causes a corresponding rotation of drum 144 or pulley 120 and a moving of vehicle physical control linkage attached thereto. Conversely, in FIG. 14B, armatures 172 of solenoids 92 are extended downward to position the race bearing and respective drum 144 or pulley 120 in a lowered position such that the male spline 138 and female spline 140 are de-coupled and rotation of control column shaft 192 and its respective male spline 138 cannot effect the rotation of drum 144 or pulley 120 or the movement of vehicle physical control linkage attached thereto. Additionally, drum 144 or pulley 120 can be equipped with one or more alignment means (not shown) as previously described, to provide proper registration or biasing of a disabled drum or pulley as the interlocking contours are being positioned together. It is noted, that one or more actuators could alternatively be positioned beneath drum 144 or pulley 120 to provide a linear positioning of the drum or pulley into or out of engagement with male spline 138 and female spline 140. It is also noted that a low-profile interlocking contour such as the type depicted in FIGS. 9, 12A-13B and FIGS. 15A and 15B can alternatively be employed in the embodiment of the disabling and enabling means depicted in FIGS. 14A and 14B (instead of male and female splines).

FIGS. 15A and 15B depict the side view of a control quadrant 116, or quadrant sector, having a low-profile male interlocking surface similar to those depicted in FIGS. 12A through 13B, wherein the male contour is co-axially aligned with and interfits with a respective female interlocking surface formed adjacent to a torque tube 128 or other member having a control input arm 106 member attached thereto. The combination of the control arm and female interlocking surface is positionable into engagement or disengagement by one or more linear actuators in the manner similar to any of those previously described. Thus, the transfer of manual vehicle control input through a quadrant, quadrant sector, pulley and the like, can be readily enabled or disabled, including the employment of control movements in the range of less than, or a fraction of, an inch, including doing so with existing, or minimally modified, aircraft or vehicle control linkage parts.

FIG. 16A is a three-dimensional illustration of a manual control linkage adjustment means commonly employed on commercial aircraft such as Boeing® 747's. The apparatus typically serves as a control quadrant cable-tension regulator, or tensioner 126. In FIG. 16B, a similar apparatus referred to herein as a quadrant adjustment means 118, is equipped with cable tension adjustment actuators 92. Rotational drive means 70 rotate lead screws 72 which rotate within respective followers 76 of carriage 78, the latter of which serves as a linearly positionable member 112. When the carriage 78 is positioned forward (forward is represented by the direction of the large black arrow) by the actuators, relative to the rotational axis of the quadrant, the tension of the physical control linkage attached to the quadrant is tightened. Conversely, when the carriage 78 is positioned backward (opposite of black arrow) by the actuators, the tension of the physical control linkage attached to the quadrant is slackened. Preferably the degree of adjustment provided is sufficient to disable manual vehicle control input to the attached physical control linkage. It is noted, that alternative linear actuation instead of that shown in FIG. 16B is also easily achieved, for example the carriage can be moved forward and back by one or more solenoids or hydraulic or pneumatic actuators.

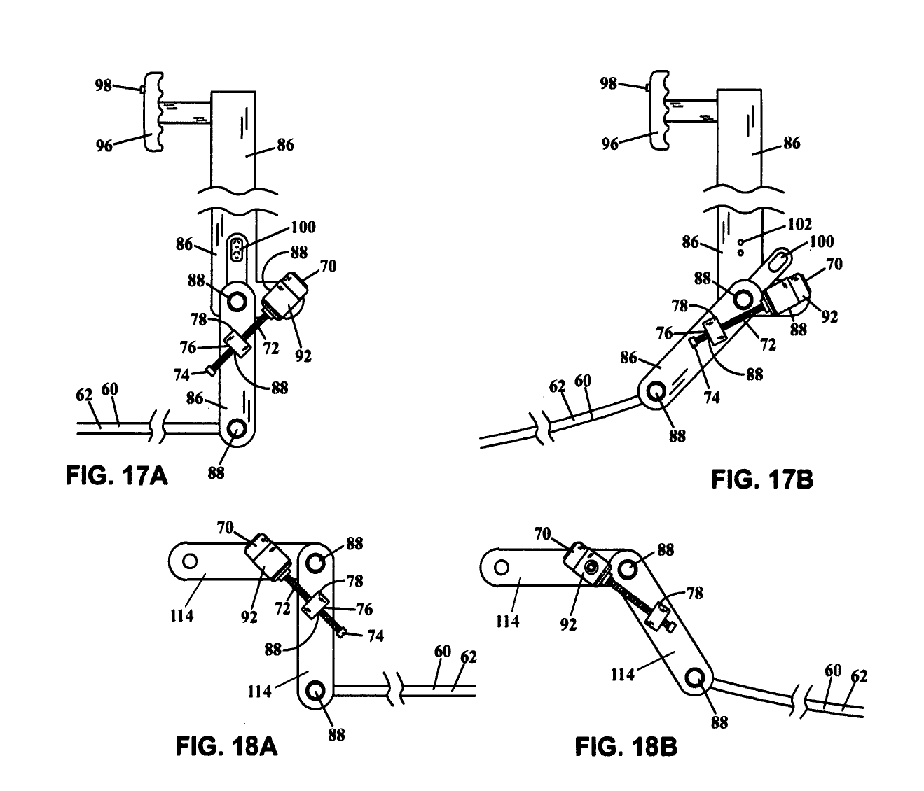

FIGS. 17A through 28B show other embodiments of disabling and enabling means which are responsive to security-related disabling or enabling control signals sent by the VSBPS and are employable as a cable tension adjustment means to slacken (disable) or tighten (enable) a control cable. Preferably redundant actuators are provided although it is noted that doing so is optional and instead a single actuator can alternatively be employed. In FIGS. 17A, 18A, 19A, 20A, 21A, 22C, 23A, 24B, 25A, 26A, 27A and 28A control cable 62 is shown in a normally-on adjusted enabled state. In FIGS. 17B, 18B, 19B, 20B, 21B, 22D, 23B, 24A, 25B, 26B, 27B and 28B cable 62 is shown adjusted in a slackened disabled state.

FIGS. 17A and 17B show side views of a jointed manual control input member 86, such as a control column, having at least one linear actuator, such as: (1) one or more rotational drive means 70 which control the rotation of a lead screw 72 in a follower 76 of a pivotably mounted carriage 78; or, (2) other electrical linear actuator 92. The actuator(s) is shown pivotably mounted on the upper member, and the follower 76 is shown pivotable mounted on the lower member. The lead screws preferably have a lead screw stop 74. Linear adjustments made by the actuator(s) controls the angle of a lower member of control input member 86 relative to the angle of an upper member and provide a range of adjustment suitable for disabling (FIG. 17B) and enabling (FIG. 17A) manual vehicle control input to the control column, or yoke 96 of the control column.

It is noted that any of the control columns depicted in the present invention can include a control yoke button 98 which is equipped to function as a wireless, or hard-wired transmitter, to transmit HJT signals, or reset signals, when needed. Preferably, to avoid false deployment of the VSBPS, such signals are transmitted following a predetermined number of rapid taps on the button e.g., three taps within 1.5 to 2 seconds. The upper end of the lower member is shown having an optional enabling/disabling lock means 100. For example, the locking means can have one or more pin, peg, threaded element, and the like, that is positionable by one or more actuators into a respective lock pin aperture 102.

FIGS. 18A and 18B are side views of a jointed manual control input member, such as an adjustable bell crank 114, having at least one linear actuator pivotably mounted thereto which controls the angle of a first control arm member of the bell crank relative to the angle of a second control arm member and solely, or in combination with other adjustment means, provides a range of adjustment suitable for disabling (or making ineffectual) as shown in FIG. 18B and enabling normal manual control input to the bell crank 114 as shown in FIG. 18A.

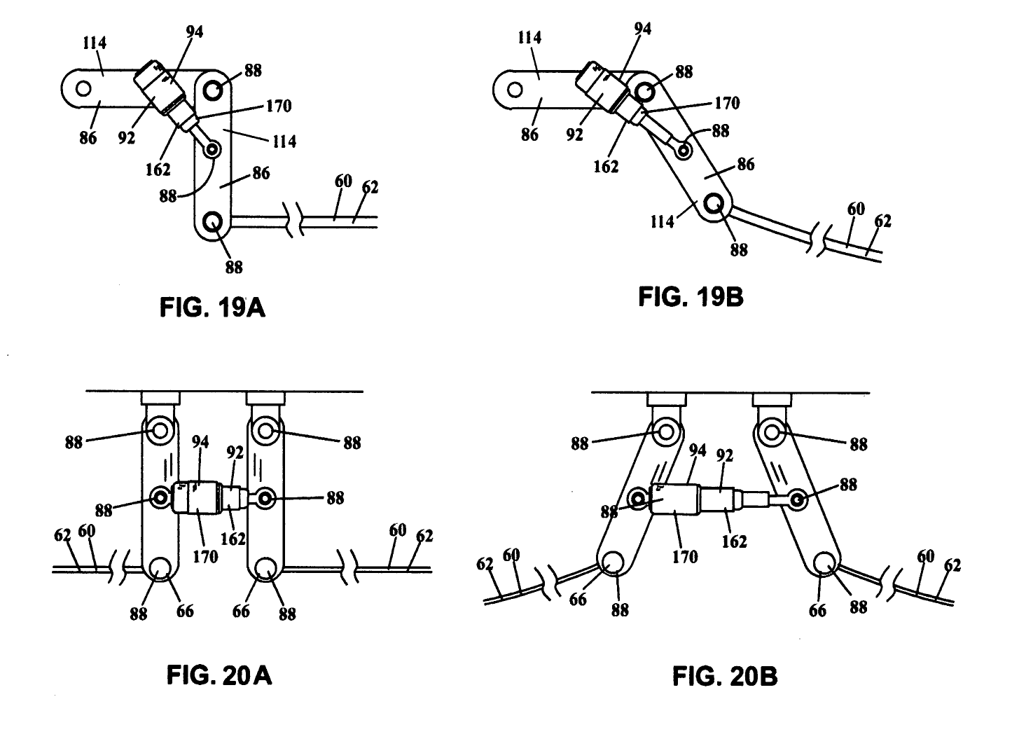

FIGS. 19A and 19B are side views of a jointed manual control input member similar to the adjustable bell crank 114 of FIGS. 18A and 18B, but instead are shown having one or more hydraulic actuator(s) 94, or pneumatic adjustment means 162, or electrical actuator(s) 92 or solenoid(s) 170 pivotably mounted thereto which controls the angle of a first control arm member of the bell crank 114 relative to the angle of a second control arm member and solely, or in combination with other adjustment means, provides a range of adjustment suitable for disabling and re-enabling normal manual control input to the bell crank 114. The members preferably have pivotable connection means 88 adjacent to each end and for pivotably attaching the linear actuating means. The pivotable connection means 88 at one end are employed to pivotably attach one member to another member. The pivotable connection means 88 at an opposite end of the members are optionally employed as a means to pivotably attach control cable end retaining means 66 which retain control cable 62 or other control linkage 60. The linear actuator(s) control the angle of a first control arm member relative to the angle of a second control arm member and solely, or in combination with other adjustment means, provide a range of adjustment suitable for disabling and enabling (or re-enabling) normal manual control input to the control linkage.

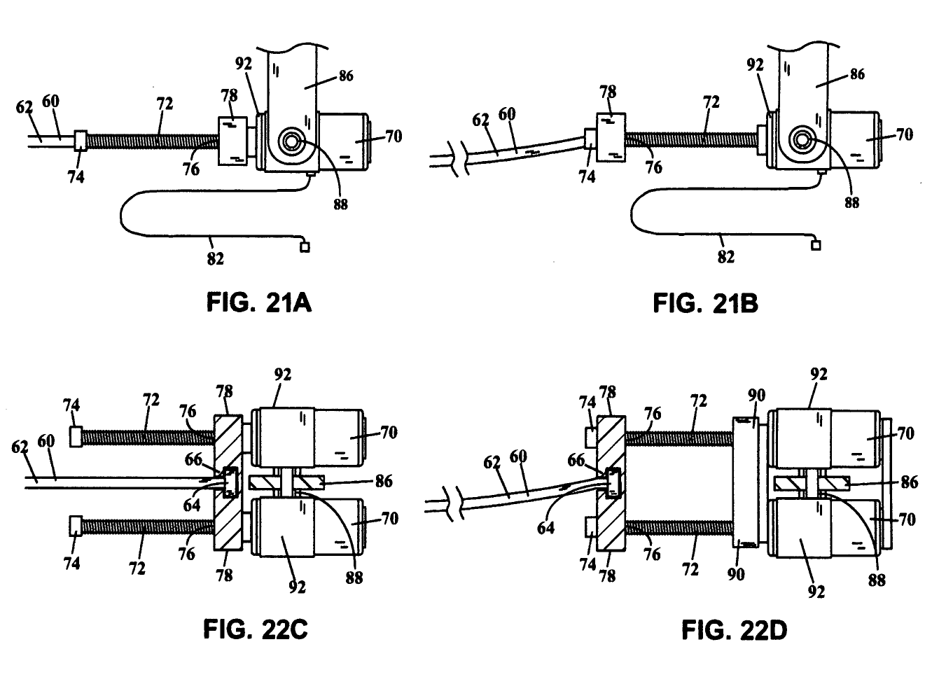

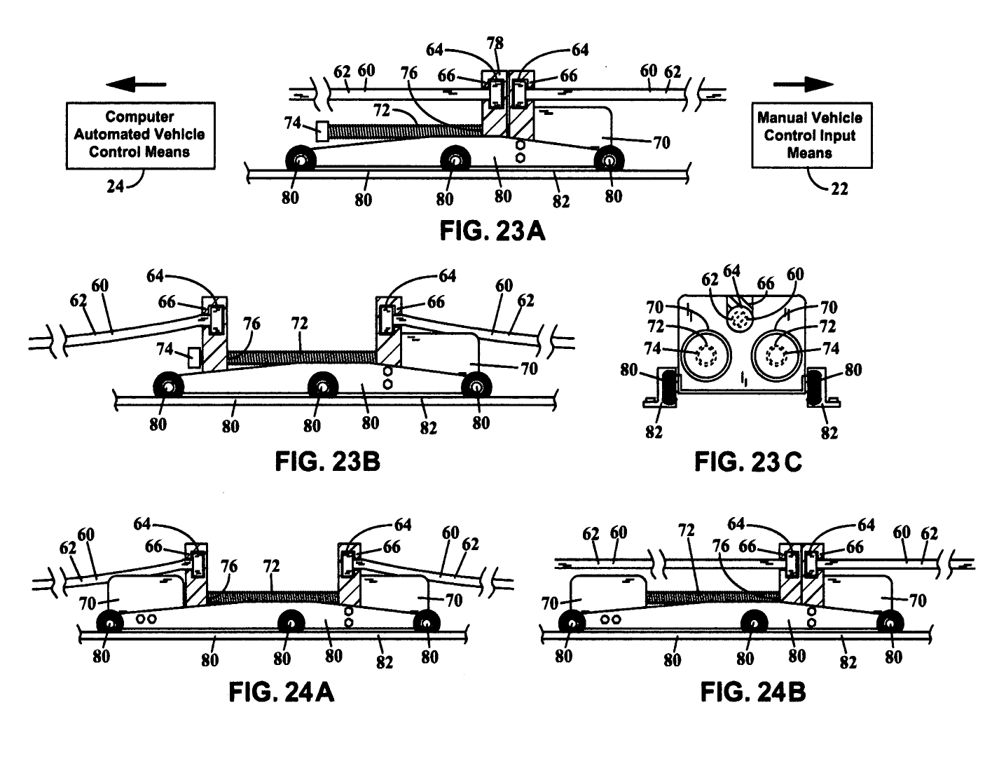

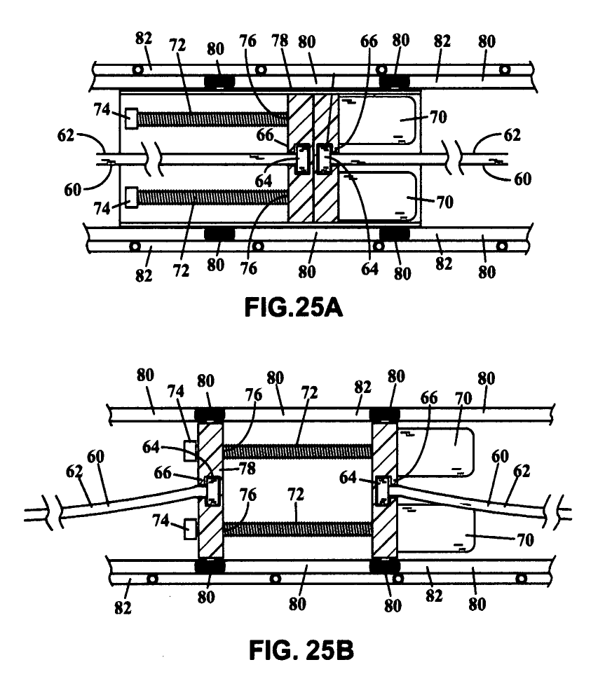

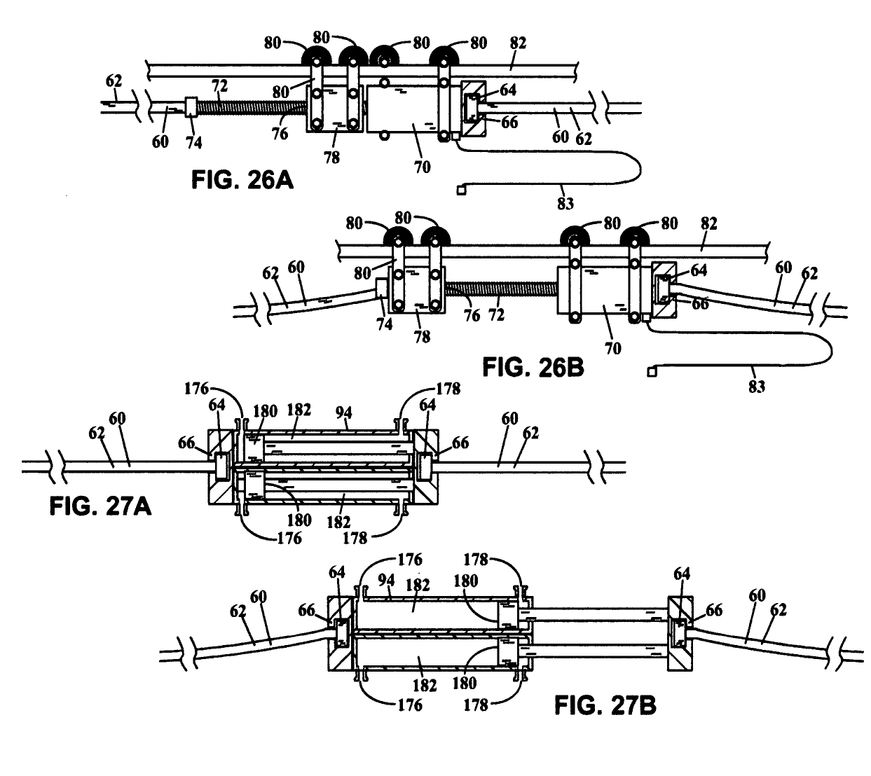

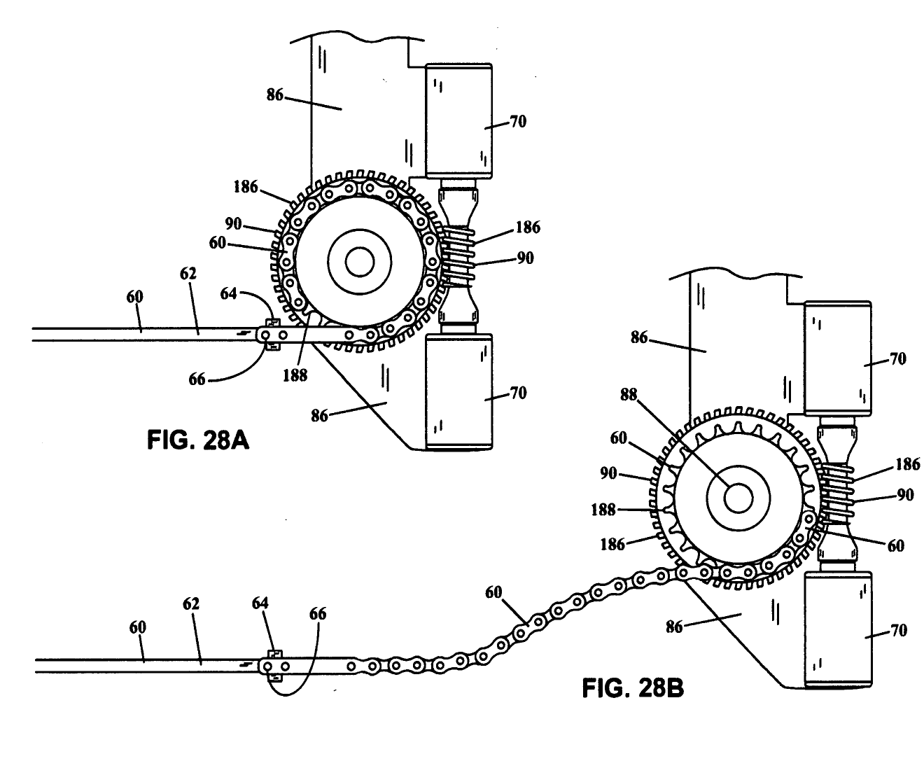

FIGS. 20A and 20B are side views of a physical linkage adjustment apparatus for transferring the manual control input received by a first member, through one or more linear actuators to a similarly configured second member. Any one or more in a variety of linear actuators can be employed, including but not limited to: hydraulic actuator(s) 94, or pneumatic adjustment means 162, or electrical actuator(s) 92 or solenoid(s) 170. Preferably, the members have pivotable connection means 88 adjacent to each end, and for pivotably attaching the linear actuating means as previously described. The upper connection means 88 are employed to pivotably mount the members to a suitable surface of the vehicle. The lower connection means 88 (at an opposite end of the members) are optionally employable as a means to pivotably attach control cable end retaining means 66 which retain control cable 62 or other control linkage 60. The linear actuator(s) control the angle of a first control arm member relative to the angle of a second control arm member and solely, or in combination with other adjustment means, provide a range of adjustment suitable for disabling as seen in FIG. 20B, and enabling (or re-enabling) as seen in FIG. 20A normal manual control input to the control linkage.

FIGS. 21A through 26B illustrate examples of other embodiments of disabling and enabling means which are responsive to security-related disabling or enabling control signals sent by the VSBPS and are employable as a cable tension adjustment means to slacken (disable) or tighten (enable) a control cable. Cable tension is achieved by actuator positioning of a cable retaining carriage 78. Preferably redundant actuators are provided, although it is noted that doing so is optional and instead a single actuator can alternatively be employed. In FIGS. 21A, 22C, 23A, 24B, 25A, 26A, 27A and 28A control cable 62 is shown in a normally-on adjusted enabled state. In 21B, 22D, 23B, 24A, 25B, 26B, 27B and 28B cable 62 is shown adjusted in a slackened disabled state.

FIGS. 21A, 21B are side views, and FIGS. 22C and 22D are top views respectively which illustrate linear actuators with pivotable connection means 88 mounted near to the end of a manual control input arm 86, or member. Each actuator has a lead screw 72 driven by rotational drive means 70 such as a stepper motor, motor or servo. Rotation of the lead screws in a follower 76, positions a carriage 78 having cable end retaining means 66 which in turn, retains a cable end 64. Thus, rotation of the lead screw(s) 72 adjusts the length of control cable 62. All other elements in the figures function as previously described. In FIG. 22D, a rotational transmission means 90 such as a belt or chain couples the rotation of motor pullies or sprockets to provide rotational drive means redundancy. While the actuators of 21A through 26B are depicted as motor driven actuators, it is noted that any one of the embodiments can alternatively be comprised of one or more hydraulic actuator(s) 94, or pneumatic adjustment means 162, or electrical actuator(s) 92 or solenoid(s) 170 or any combination thereof. The side views of FIGS. 23A, 23B, 24A and 24B illustrate similar linear actuating means configured for adjusting the tension of vehicle control linkage. The apparatus is supported by friction-reducing means 80 such as wheels or bearings preferably operative in a guide track, to facilitate low-drag, repeated push-pull movement of its respective control linkage. Each actuator rotationally drives a lead screw driven by rotational drive means such as a stepper motor, motor or servo. Rotation of the lead screws positions a carriage which in turn, adjusts the operative length of control linkage attached to the carriage. All other elements in the figures function as previously described. In FIG. 23A, the manual control input disabling and enabling apparatus is depicted positioned between manual vehicle control input 22 (located in the direction of the right-pointing arrow) and computer automated vehicle control means 24 (located in the direction of the left-pointing arrow). Thus, when the control cable 62 is slackened to a disabled or ineffectual state, computer automated vehicle control means 24 controls vehicle control linkage components downstream in a normal automated manner. FIG. 23C is an end view of apparatus similar to those shown in FIGS. 23A, 23B, 24A and 24B. In FIG. 23C guide rails 82 are shown encompassing friction reducing means 80, e.g. wheels or bearings, to prevent the latter from becoming derailed, for example during turbulent conditions.

The apparatus of FIGS. 23C, 24A and 24B are shown having rotational drive means redundancy. In FIG. 23C, the apparatus can optionally include a rotational transmission means such as a belt or chain for coupling the rotation of motor-driven pullies or sprockets (not shown). In FIGS. 24A and 24B redundant rotational drive means drive the same lead screw. All other elements in the figures function as previously described.

FIGS. 25A and 25B are top views of the physical control linkage adjustment means shown in FIGS. 23A and 23B respectively. FIG. 25A depicts the control cable 62 in an enabled state. FIG. 25B depicts control cable 62 in a disabled state. All elements in the figures function as previously described.

FIGS. 26A and 26B are side views of physical control linkage adjustment means similar to those depicted in FIGS. 23A and 23B respectively. The apparatus of FIGS. 26A and 26B are alternatively shown suspended from upper friction-reducing means 80, to facilitate low-drag, repeated push-pull movement of their respective control linkage. A flexible conduit 83 such as a ribbon cable accommodates normal back-and-forth of the control linkage adjustment means. All other elements in the figures, and all variants thereof, function as previously described.

FIGS. 27A and 27B are partial cross-sectional top views of physical control linkage adjustment means that are equipped to be responsive to hydraulic or pneumatic pressurization to (1) disable manual input of attached control linkage (FIG. 27B), or (2) to enable or re-enable manual control input of attached control linkage (FIG. 27A). Preferably, the adjustment means provides redundancy, for example, by providing tandem pressurizing linear actuators 94 each equipped with apparatus disabling pressurization ports 176 and apparatus enabling pressurization ports 178. Pressurization applied to port(s) 178 provides pressure on piston(s) 180 which moves or retains cable end retaining means 66, control cable 62 and respective control linkage 60 in an enabled state as depicted in FIG. 27A. Pressurization applied to port(s) 176 provides pressure on piston(s) 180 which moves cable end retaining means 66, control cable 62 and respective control linkage 60 to a disabled state as depicted in FIG. 27B. Actuators 94 can be positioned in-line as shown between two lengths of control cables 62 or other physical linkage 60, or can be pivotably mounted at one end to a manual input control member as previously described. All other elements in the figures, and all variants thereof, function as previously described.

FIGS. 28A and 28B are side views of physical control linkage adjustment means mounted near the end of a manual control input arm 86, or member. The apparatus is equipped with rotational drive means 70 such as stepper motors, motors or servos, and rotational transmission means 90 for transferring the drive means rotation to a gear-driven sprocket 188 to disable or re-enable manual control input to the physical control linkage attached thereto. Preferably the rotational drive means 70 is configured in a redundant manner (as shown). All other elements in the figures, and all variants thereof, function as previously described.

Thus, a variety of embodiments of a vehicle suicide-bombing prevention system ‘VSBPS’ is provided, for preventing the suicide-bombing of a transportation vehicle, comprising one or more onboard computer capable of safely operating the vehicle in one or more automated transportational mode along one or more path. The VSBPS is also comprised of one or more manual control input disabling means having a communications link with, the computer(s), and the computer(s) and the manual control input disabling means are configured to receive and be responsive to one or more hijack threat event control signal. The computer(s) have one or more software routine which is implemented when the control signal is received, to
a provide automated vehicle control data to the onboard computer(s) to safely operate the vehicle in one or more automated transportational mode; and
b. transmit one or more control signal to the vehicle control disabling means to disable manual vehicle control input of the vehicle.

The computer(s) having one or more software routine which is implemented when the security-related or hijack threat event control signal is received, to provide automated vehicle control data to the onboard computer(s) that are equipped to safely operate the vehicle in one or more automated transportational mode. The VSBPS has means for transmitting one or more control signal to the vehicle control disabling and re-enabling means to disable manual vehicle control input of the vehicle, and the computer(s) have one or more software routine which is implemented when the hijack threat event reset signal is received, to transmit one or more control signal to the vehicle control disabling and re-enabling means to re-enable manual vehicle control input of the vehicle. Preferably, one or more manual control input disabling and re-enabling means is/are adjustable by one or more linear actuators providing a plurality of positionings of which at least one positioning is a normally-on state not requiring: (a) an electrical current, or (b) a pneumatic or hydraulic pressure change or pressurized state to maintain or retain the positioning. Or, one or more manual control input disabling and re-enabling means is/are adjustable by one or more actuators which is/are configured in a normally-on position providing manual vehicle control input during normal operation of a vehicle without requiring adjustments to the actuator(s).

Preferably the VSBPS further comprises one or more disabling means sensors and/or one or more enabling means sensors for sensing and reporting the status of the disabling and/or enabling means.

Optionally, the VSBPS provides a vehicle disabling mode which is implemented within a pre-determined time frame when a vehicle has come to a full stop. For example, after an aircraft has safely landed and taxied to a safe location, the VSBPS can optionally be equipped to place the landed aircraft in a configuration impossible for takeoff and obvious to observers that the aircraft is in a landed, stopped and pre-VSBPS-reset configuration. For example, including, but not limited to, any one or combination of the following configurations: full down elevator, full left rudder, full right-roll ailerons, locked brakes, flaps up, flight controls locked, nose gear turned hard-right or hard-left, and the like. The disabled state of the vehicle can be maintained until one or more authorized ground-based personnel confirm that the status of the vehicle is safe and return the VSBPS to a normal operating status. Optionally, the authorized personnel can have a secure password, or other security clearance means, which is used as a prerequisite to returning the vehicle to an operational mode.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the specification and any claims to follow.

1. A VSBPS for preventing the suicide-bombing of a transportation vehicle, comprising:
1. at least one onboard computer capable of safely operating the vehicle in at least one automated transportational mode along at least one path, and said computer(s) having a communication link with at least one receiver configured to receive a transmitted security related control signal;
2. at least one manual control input disabling and re-enabling means for adjusting the linkage of at least one vehicle control means within a linkage enabling and linkage disabling range, said manual control input disabling means having a communications link with said computer(s), wherein
a. said computer(s) and said manual control input disabling means are configured to receive and be responsive to a transmission of at least one security related control signal received via said communications link, and
b. said computer(s) has at least one software routine which is implemented when said control signal(s) is received, to
i. provide automated vehicle control data to safely operate the vehicle in at least one automated transportational mode, and
ii. provide at least one control signal to said vehicle control disabling and re-enabling means to disable or re-enable manual vehicle control input of the vehicle.

2. A vehicle suicide-bombing prevention system ‘VSBPS’ for preventing the suicide-bombing of a transportation vehicle, comprising:
1. at least one onboard computer capable of safely operating the vehicle in at least one automated transportational mode along at least one path, and said computer(s) having a communication link with at least one receiver configured to receive a transmitted security related control signal;
2. at least one manual control input disabling means for adjusting the linkage of at least one vehicle control means within a linkage enabling and linkage disabling range, said manual control input disabling means having a communications link with said computer(s), wherein
a. said computer(s) and said manual control input disabling means are configured to receive and be responsive to a transmission of at least one security related control signal received via said communications link, and
b. said computer(s) has at least one software routine which is implemented when said control signal(s) is received, to
i. provide automated vehicle control data to safely operate the vehicle in at least one automated transportational mode, and
ii. provide at least one control signal to said vehicle control disabling means to disable manual vehicle control input of the vehicle.

3. The VSBPS of claim 2 further comprising said at least one vehicle manual control input disabling means connected within vehicle control components of a vehicle at a position subsequent to where manual vehicle control input is initiated and prior to where vehicle control components are controllable by computer automated vehicle control means, and said input disabling means is configured to be responsive to said security related control signal(s) to adjust at least one vehicle control component attached thereto to a degree where manual vehicle control input of the vehicle is ineffectual.

4. The VSBPS of claim 1 further comprising at least one vehicle manual control input disabling and re-enabling means connected within vehicle control components of a vehicle at a position subsequent to where manual vehicle control input is initiated and prior to where vehicle control components are controllable by computer automated vehicle control means, and said input disabling and re-enabling means is configured to be responsive to said security related control signal(s) to adjust at least one vehicle control component attached thereto in a bistate manner, wherein:
a. in a first state, said input disabling and re-enabling means respond to said control signal(s) placing the vehicle control component(s) in a disabled state such that manual control input is ineffectual, and
b. in a second state, said input disabling and re-enabling means respond to said control signal(s) placing the previously disabled manual vehicle component(s) in a re-enabled state which provides normal manual control input.

5. The VSBPS of claim 1 wherein at least one of said vehicle control components is a control cable, and said at least one input disabling and enabling means is comprised of at least one actuator configured to adjust the effective length of the control cable to either:
a. a disabled state wherein the cable length is slackened to a degree wherein manual control input to the control cable is ineffectual, or
b. an enabled state wherein the cable length is adjusted to a degree wherein manual control input to the control cable is provided.

6. The VSBPS of claim 1 wherein at least one of said vehicle control components is a bistate push-pull member having a slideable disabled state and a non-slideable enabled state controllable by at least one manual control input disabling and enabling means comprised of at least one actuator retainer, wherein
a. said push-pull member is in an enabled state and manual control input to the member is provided when said actuator retainer retains said member in a non-slideable condition, and
b. said push-pull member is in a disabled state and manual control input to the member is disabled when said actuator retainer is in a non-retaining condition permitting a slideable member state wherein manual control input to the member is ineffectual.

7. The VSBPS of claim 1 wherein at least one of the vehicle control components is a push-pull member, and at least one actuator of the vehicle manual control input disabling and enabling means is configured to adjust the effective length of the member to a degree where manual control input to the push-pull member is ineffectual.

8. The VSBPS of claim 1 wherein at least one of the vehicle control components is a hydraulic pressure control means, and at least one vehicle manual control input disabling and enabling means is configured to adjust the hydraulic pressure of the pressure control means to a degree where manual control input to the hydraulic pressure control means is ineffectual.

9. The VSBPS of claim 1 wherein at least one of the vehicle control components is a hydraulic pressure control means, and at least one vehicle manual control input disabling and enabling means is configured to adjust the hydraulic pressure of the pressure control means to either:
a. a state wherein manual control input to the hydraulic pressure control means is disabled and ineffectual, or
b. a state wherein manual control input to the hydraulic pressure control means is re-enabled providing normal operation.

10. The VSBPS of claim 1 wherein at least one manual control input disabling and re-enabling means is adjustable by at least one linear actuator.

11. The VSBPS of claim 1 wherein at least one manual control input disabling and re-enabling means is adjustable by at least one linear actuator providing a plurality of positionings of which at least one positioning does not require current to maintain or retain said positioning.

12. The VSBPS of claim 1 wherein at least one manual control input disabling and re-enabling means is adjustable by at least one hydraulic actuators which are equipped to provide at least one positioning not requiring a pressurized state to maintain or retain said positioning.

13. The VSBPS of claim 1 wherein at least one manual control input disabling and re-enabling means is adjustable by at least one pneumatic actuators which are equipped to provide at least one positioning not requiring a pressurized state to maintain or retain the positioning.

14. The VSBPS of claim 1 wherein at least one manual control input disabling and re-enabling means is adjustable by at least one actuator within a range of a fraction of an inch to change said disabling and re-enabling means between a disabled and enabled state.

15. The VSBPS of claim 1 wherein at least one actuator adjust manual control input disabling and re-enabling means comprised of at least one existing vehicle part.

16. The VSBPS of claim 1 wherein at least one actuator adjust manual control input disabling and re-enabling means comprised of at least one partially modified vehicle part.

17. The VSBPS of claim 1 wherein at least one manual control input disabling and re-enabling means is comprised of at least one existing vehicle part adjustable by at least one actuator.

18. The VSBPS of claim 1 wherein at least one manual control input disabling and re-enabling means is adjustable by at least one actuator which is configured in a normally-on position providing manual vehicle control input during normal operation of a vehicle without requiring adjustments to said actuator(s).

19. The VSBPS of claim 1 wherein at least one manual control input disabling and re-enabling means is adjustable by at least one hydraulic pressure control means.

20. The VSBPS of claim 1 wherein at least one manual control input disabling and re-enabling means is adjustable by at least one pneumatic pressure control means.

21. The VSBPS of claim 1 wherein at least one manual control input disabling and re-enabling means is adjustable by at least one electromechanical actuator.

22. The VSBPS of claim 1 wherein at least one manual control input disabling and re-enabling means has at least one hydraulic pressure adjustment means which is adjustable by at least one hydraulic pressure control means.

23. The VSBPS of claim 1 wherein at least one manual control input disabling and re-enabling means has at least one pneumatic pressure adjustment means which is adjustable by at least one pneumatic pressure control means.

24. The VSBPS of claim 1 wherein at least one manual control input disabling and re-enabling means is further comprised of a bistate locking and unlocking means which is positionable by at least one actuator, wherein
a. when the lock is positioned in a normally-on locked state, control input disabling and re-enabling means is in a non-adjustable state and normal manual vehicle control input is provided, and
b. when the lock is positioned in an unlocked state, control input disabling and re-enabling means is adjustable to a degree where manual vehicle control input is disabled.

25. The VSBPS of claim 1 wherein at least one input disabling and re-enabling means is connected with, and is controlled by, a plurality of actuators which are configured to operate in a redundant manner.

26. The VSBPS of claim 1 further comprising:
a. at least one transmitter means equipped to send security related control signal;
b. said at least one receiver means equipped to receive said security related control signals from said transmitter(s);
c. said receiver means having a communications link with at least one computer(s) for conveying security related communication from the receiver(s) to the computer(s); and
d. said computer(s) having a communications link with said at least one disabling and enabling means to change the disabling and re-enabling means between a disabled and enabled state.

27. The VSBPS of claim 26 wherein said at least one transmitter means consists of a portable wireless transmitter equipped to transmit secure signal.

28. The VSBPS of claim 26 wherein said at least one transmitter means is comprised of:
a. a compact, portable wireless transmitter easily concealed for anonymously triggering, and equipped to transmit secure signal,
b. said transmitter having an accessible security signal activation button which is easily located by touch, and
c. said transmitter is configured to send said security signal following the firm, rapid tapping of the button a plurality of times within a predetermined time limit.

29. The VSBPS of claim 26 wherein at least one transmitter means is a portable cell phone.

30. The VSBPS of claim 26 wherein at least one transmitter means is a portable cell phone and the security control signal is initiated by pressing the sequence of numbers “9” “1” “1” on the dial pad of said phone.

31. The VSBPS of claim 26 wherein at least one transmitter means is mounted on an surface of a vehicle which is readily accessible to authorized vehicle personnel.

32. The VSBPS of claim 26 wherein at least one transmitter means is mounted on an surface of a vehicle which is readily accessible to passengers.

33. The VSBPS of claim 26 wherein at least one transmitter means is mounted on an accessible surface of a manual input control of a vehicle.

34. The VSBPS of claim 26 wherein at least one transmitter means is an electrical button mounted on an accessible surface of a manual input control of a vehicle and at least one receiver means is equipped to receive button-on signal when the button is depressed by a user and to convey a communication pertaining to said security related control signal to at least one input port of said computer(s).

36. The VSBPS of claim 26 wherein at least one transmitter means is a surface mounted transmitter and the security related control signal(s) is transmitted through at least one conduit connected between the transmitter means and the receiver(s).

37. The VSBPS of claim 26 wherein at least one transmitter means is further comprised of electrical components capable of transmitting audio signal.

38. The VSBPS of claim 26 wherein at least one transmitter means is further comprised of electrical components capable of transmitting video signal.

39. The VSBPS of claim 26 wherein at least one transmitter means is further comprised of electrical transceiver and audio playback components capable of transmitting, receiving and playing back audio signal.

40. The VSBPS of claim 26 wherein at least one transmitter means is further comprised of electrical transceiver and video playback components capable of transmitting, receiving and playing back video signal.

41. The VSBPS of claim 26 wherein at least one transmitter means is further comprised of electrical transceiver and audio/video components capable of transmitting, receiving and playing back audio and video signal.

42. The VSBPS of claim 26 wherein at least one transmitter means is further comprised of:
a. electrical transmitter and voice transmission components capable of securely transmitting voice-audio signal, and
b. the combination of said at least one receiver means and said computer(s) further comprised of components and software
i. for receiving, processing and analyzing the voice-audio signal,
ii. for performing voice-stress analysis,
iii. for sending at least one security related control signal to said disabling and enabling means when said analysis indicates at least one voice-stress level is within a pre-determined range of voice-stress levels.

43. The VSBPS of claim 26 wherein at least one transmitter means is further comprised of:
a. electrical transmitter and voice transmission components capable of securely transmitting voice-audio signal, and
b. the combination of said at least one receiver means and said computer(s) further comprised of components and software
i. for receiving, processing and analyzing the voice-audio signal,
ii. for performing voice-recognition analysis,
iii. for sending at least one security related control signal to said disabling and enabling means when said analysis indicates at least one voice-recognition parameter is within a pre-determined range.

44. The VSBPS of claim 26 wherein at least one transmitter means is further comprised of:
a. electrical transmitter and image transmission components capable of securely transmitting video-image signal, and
b. the combination of said at least one receiver means and said computer(s) further comprised of components and software
i. for receiving, processing and analyzing the video-image signal,
ii. for performing image-recognition analysis,
iii. for sending at least one security related control signal to the disabling and enabling means when said analysis indicates at least one image-recognition parameter is within a pre-determined range.

45. The VSBPS of claim 26 wherein at least one transmitter means is further comprised of electrical transceiver components.

46. The VSBPS of claim 1 further comprising at least one facility transmitter means having electrical components capable of transmitting at least one secure, security-related control signal from at least one secure facility to said receiver means of said transportation vehicle, wherein
a. said receiver means has a communications link with said computer(s) and is further comprised of electrical components capable of receiving at least one secure security control signal from said facility transmitter means.

47. The VSBPS of claim 46 wherein said receiver means and said computer(s) aboard said transportation vehicle are further comprised of:
a. electronic signal reception components for receiving secure security-related control signal transmitted from at least one secure facility and for communicating at least one control signal to said disabling and enabling means,
b. said secure security-related control signal is further comprised of data pertaining to the selection of at least one automated transportation mode path, and
c. said computer(s) responsive to said data in a manner which controls the vehicle in accordance with said automated transportation mode path(s).

48. The VSBPS of claim 26 wherein said at least one transmitter means is equipped to send at least one security-related reset signal to said at least one receiver means interfaced with at least one computer(s), and said computer(s) is responsive to said reset signal(s) to change said at least one disabling and re-enabling means from a disabled to an enabled state.

49. The VSBPS of claim 1 further comprising:
1. manual vehicle control input monitoring means having at least one sensor for measuring manual vehicle control input pertaining to at least one manual vehicle control;
2. said monitoring means having a communication link with said at least one computer(s);
3. said computer(s) having
a. a data reference storage and retrieval means for storing and retrieving data pertaining to predetermined acceptable ranges of manual control input relative to predetermined transportation modes;
b. at least one software routine for automatically comparing said degree of manual vehicle control input relative to said data, such that when said software routine(s) determines that at least one type of manual vehicle control input occurring during at least one transportation mode exceeds a pre-determined acceptable range of input:
i. a security related control signal is communicated to said at least one disabling and re-enabling means to disable manual control input, and
ii. said vehicle is placed in at least one automated transportational mode.

50. The VSBPS of claim 1 further comprising:
1. said vehicle having fly-by-wire ‘FBW’ vehicle control means;
2. said FBW vehicle control means equipped to translate manual vehicle control input into FBW control input data; and
3. said vehicle manual control input disabling and re-enabling means is interfaced with said FBW vehicle control means, such that reception of said at least one security related control signal by said computer(s),
a. disables control signal pertaining to manual vehicle control input from being transmitted to the actuator control electronics of the vehicle; and
b. enables control signal pertaining to at least one computer automated transportation mode to be transmitted to the vehicle's actuator control electronics.

51. The VSBPS of claim 50 wherein at least one receiver having a communication link with said computer(s) is equipped to receive at least one authorized system reset signal, such that when said reset signal is received, normal manual control input of said FBW vehicle is re-enabled.

52. The VSBPS of claim 1 wherein said vehicle upon coming to a halt is automatically placed in a configuration which makes the vehicle inoperable until authorized personnel board said vehicle to reset the system, returning it to an operable condition when it is determined that it is safe to do so.
